(19) United States
(12) Patent Application Publication
(10) Pub. No.: US 2007/0009229 A1
(43) Pub. Date: Jan. 11, 2007

(54) User interface for consumer electronic product

(75) Inventor: Jianyun Liu, Hermitage, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, LLC, Wayne, NJ (US)

(21) Appl. No.: 11/434,210

(22) Filed: May 16, 2006

Related U.S. Application Data
(60) Provisional application No. 60/681,164, filed on May 16, 2005.

(51) Int. Cl. H04N 5/91

(52) U.S. Cl. 386/83

(57) ABSTRACT

A channel list is generated based, for example, on tuning operations of a tuner of a television. An interface displays at least a portion of the channel list and allows for user-selection of a channel from the channel list so that the selected channel may be tuned.

### CROSS-REFERENCE TO RELATED APPLICATION

This application claims priority to provisional application No. 60/681,164, filed May 16, 2005, the contents of which are incorporated herein in their entirety.

### BACKGROUND AND SUMMARY

The subject application generally relates to a user interface for a consumer electronic product such as a television.

The increasing complexity of consumer electronic products such as televisions and of the systems in which these products are incorporated (e.g., cable and satellite television systems with hundreds of channels) make it more difficult for users to use the products and take full advantage of the functionality that these products provide. Operations of these products that in the past were relatively straightforward and simple have become more difficult.

For example, it can be difficult to channel “surf” or “browse” to find programs of interest when a television receives hundreds of channels. In addition, with the advent of digital channels, even the task of simply tuning to a channel can involve entering a channel and sub-channel (such as 118-1) and can take up to five or more key presses on a keypad of a remote control or a front panel. Thus, surfing from one channel to another by entering different channel numbers is time-consuming and prone to error since so many numbers must be entered to surf to a series of different channels. When there are hundreds of channels and each channel may involve both channel and sub-channel numbers, even remembering which channels to surf to can be a difficult task.

The present application describes an example interface that facilitates channel surfing and browsing and provides access to other numerous other user-friendly features.

By way of example, a channel list is generated, for example, based on tuning operations of a tuner of a television. An interface displays at least a portion of the channel list and allows for user-selection of a channel from the channel list so that the selected channel may be tuned.

These and other features and advantages will be better and more completely understood by referring to the following detailed description of example embodiments in conjunction with the drawings.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is a generalized block diagram of an illustrative television in which the example interface may be implemented.

FIG. 2A shows an example key pad for remote control 250 of FIG. 1.

FIG. 2B shows another example remote control 280.

FIGS. 3A-3O are illustrative screen displays for explaining an example channel browser feature of the user interface.

FIGS. 4A and 4B are illustrative screen displays for explaining an example BROWSE feature.

FIG. 5 shows a channel ranking list usable in connection with an example NAVIGATE feature.

FIGS. 6A-6P are illustrative screen displays for explaining the example NAVIGATE feature.

FIGS. 7A-7C are illustrative screen displays for explaining an example FAVORITE feature.

FIGS. 8A and 8B are illustrative screen displays for explaining an example HISTORY feature.

FIG. 9 is an illustrative screen display for explaining an example OPTIONS feature.

FIG. 10 shows another illustrative browser bar that may be used in the example user interface described herein.

FIG. 11 shows an illustrative screen display for explaining an example method of customizing a channel or channel/input list.

FIG. 12 shows a portion of another illustrative browser bar that may be used in the interface described herein.

FIGS. 13A-13C are illustrative display portions for explaining an example favorite channel feature.

FIG. 14 shows a display portion for explaining an example channel list feature.

FIG. 15 shows display portions for explaining an alternate manner of setting a HOME channel.

FIGS. 16A-16E show displays for explaining a channel surfing operation using the interface described herein.

FIG. 17 is another example display screen used to explain configuring the interface described herein.

FIGS. 18A-18E are example display screen used to explain switching lists.

FIGS. 19A and 19B are example display screen portions used to explain the operation of Page ± buttons of a remote control when lists such as those in FIGS. 18A-18E are displayed.

FIGS. 20A-20D are example channel browser lists that include channel status information.

### DETAILED DESCRIPTION OF EXAMPLE EMBODIMENTS

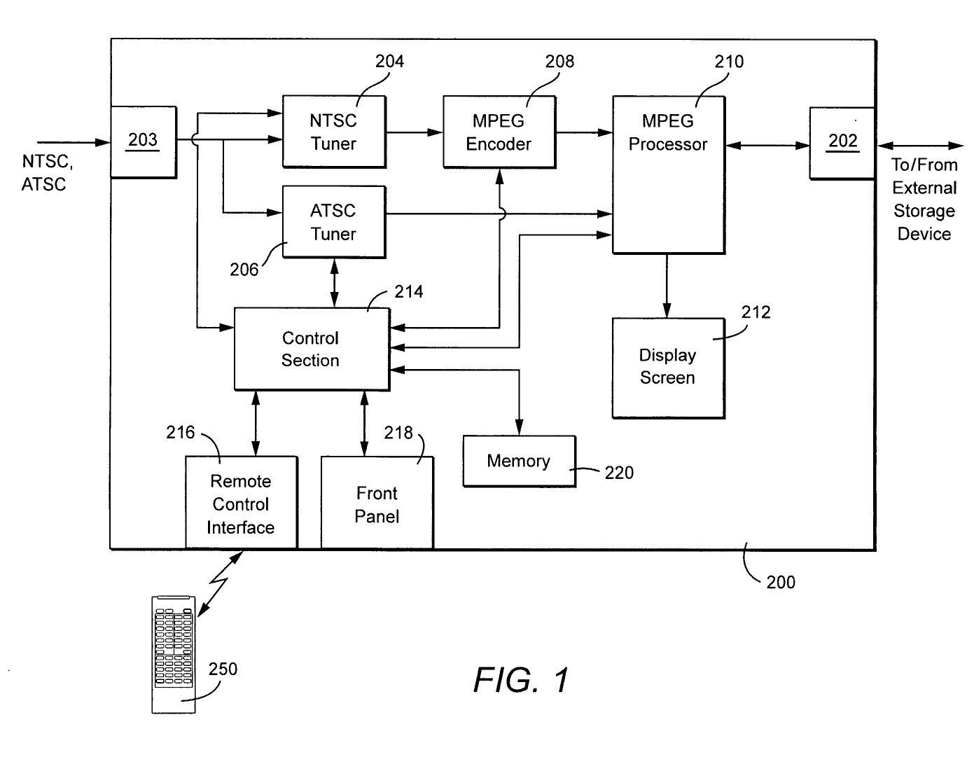

FIG. 1 is a highly generalized block diagram of a television in which the example interface described herein may be implemented. The details of the television are provided by way of example only and it will be readily apparent that the interface may be implemented in a wide variety of televisions of different configurations, both analog and digital.

An input 203 of the television receives NTSC and ATSC signals. The NTSC signals are supplied to an NTSC tuner 204 and the ATSC signals are supplied to an ATSC tuner 206. Other inputs (not shown) may also be supplied to the television. For example, the television may receive HDMI signals or the output from a DVD player. The output of NTSC tuner 204 is supplied to an MPEG encoder 208 which MPEG encodes the tuned NTSC signal. The outputs of ATSC tuner 206 and MPEG encoder 208 are supplied to an MPEG processor 210. MPEG processor 210 processes the MPEG transport stream from the ATSC tuner 206 and/or MPEG encoder 208 and supplies a display signal to display screen 212. MPEG processor 210 also selectively outputs an MPEG transport stream to and receives an MPEG transport stream from an external storage system via interface 202. The external storage system may, for example, include a hard disk drive (HDD) recording device, a DVD recording device, or an HDD/DVD recording device. Generally speaking, MPEG processor 210 is a standard processing device used in conventional digital integrated televisions, monitors and set-top box (STB) units that receives MPEG compressed AV data and decompresses and processes the AV data for display.

A control section 214, including a CPU, for example, controls the overall operations of television 200. In general, control section 214 may include, for example, a microprocessor, a microcontroller, an application specific integrated circuit (ASIC), logic circuitry, a state machine and/or combinations thereof. Control section 214 may be supplied with user inputs via a remote control interface 216 for a remote control 250 (e.g., an infrared remote control) and front panel keys 218.

Memory 220, which may be a combination of volatile and non-volatile semiconductor memory, stores various operating programs and user settings used by control section 214 to control the operation of television 200. For example, memory 220 may store an operating program for execution by the control section 214 to implement the interface described herein. This operating program may provide for control of tuners 204, 206; control of MPEG processor 210 to generate displays for display on display screen 212; processing of inputs supplied by a user via front panel 218 and/or remote control 250; and the like.

In the example embodiment, television 200 is also provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to the external storage device via interface 202). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

The interface described herein provides viewers new ways to interact with the television 200. In the disclosed implementation, web-like forms are used, although implementation of the features described herein is not limited to such forms.

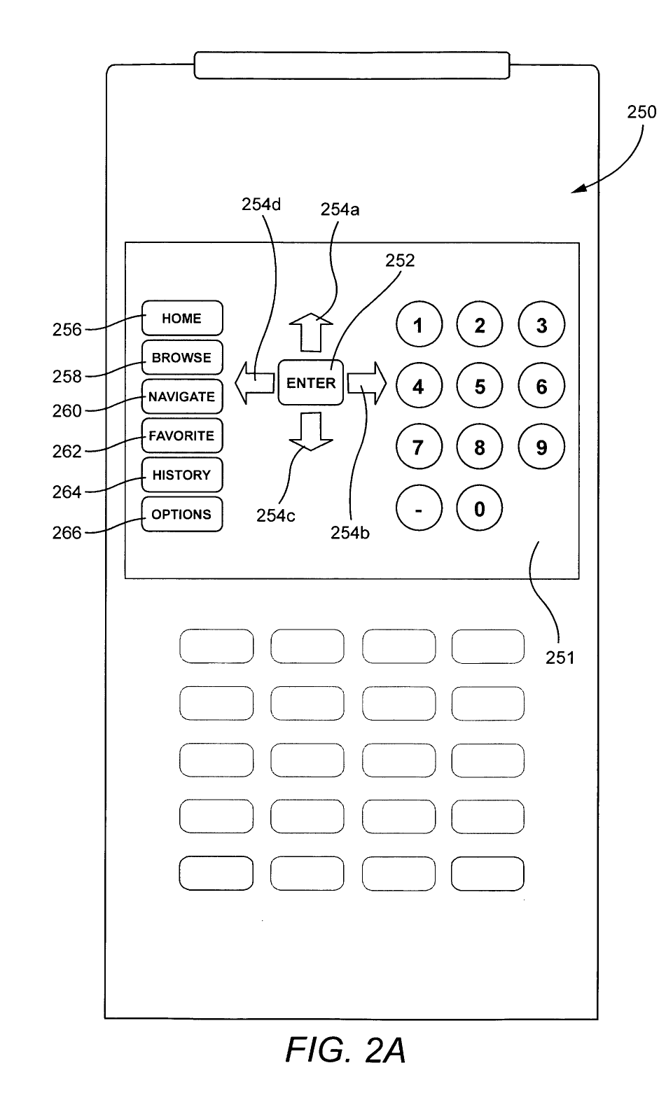

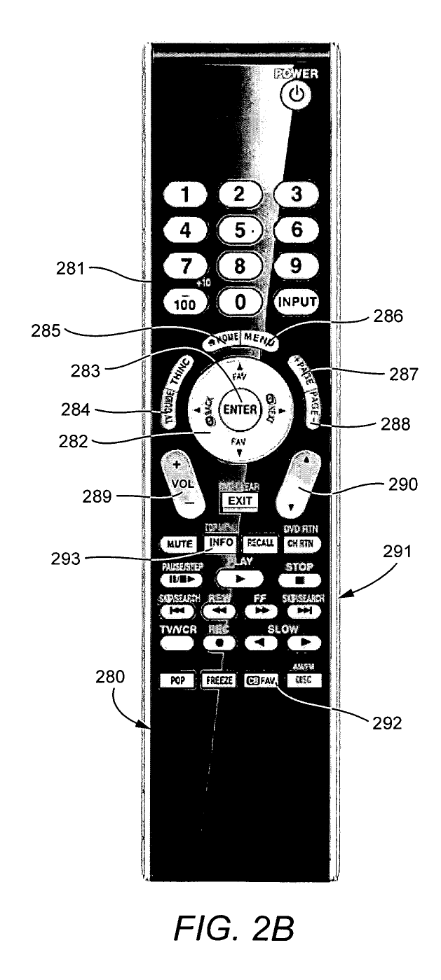

FIG. 2A shows an example keypad for remote control 250 by which a user can provide inputs to the user interface. In the example embodiment, remote control 250 includes various input devices such as keys and buttons that can be used by the user to input various commands. The keys or buttons of the remote control used for inputting these commands may be appropriately labeled to assist the user in selecting a desired function. Alternatively or additionally, the television may provide one or more displays that inform the user which key(s) or button(s) should be actuated to input desired commands. Other types of inputs such as voice inputs may also be used to input commands in certain implementations. As shown in FIG. 2A, remote control 250 includes a numeric keypad 251 with numbered keys 0-9, an enter key 252, navigation arrows 254a-d (up, down, left, right, respectively), and HOME, BROWSE, NAVIGATE, FAVORITE, HISTORY and OPTIONS keys 256-266 respectively.

The layout of the keys and buttons shown in FIG. 2A is not intended to be limiting in any way and various designs for laying out these keys and buttons may be adopted. By way of further example without limitation, FIG. 2B shows a remote control 280 having an alternate layout of keys and buttons. Remote control 280 includes a numeric keypad 281 including the numbers 0-9. Keypad 281 also includes a “−/100” key for use in entering channel numbers greater than 100 and a delimiter between major and minor channel numbers (e.g., channel 125-3). An “Input” key is provided for use in switching between different inputs to television 200 (e.g., different antennas, different video inputs, different devices connected to the television, etc.). Remote control 280 also includes a navigation switch 282 that provides for up, down, left and right navigation through menus, program guides, and the like. An enter key 283 is also provided. Various keys are provided around part of the periphery of navigation switch 282. A “program guide” key 284 causes a program guide to be displayed. A “home” key 285 causes television 200 to tune to a HOME channel as discussed in greater detail below. A “menu” key 286 causes television 200 to display an initial menu screen for accessing various features of television 200. A “Page +” key 287 and a “Page −” key 288 provide for navigation through menus, program guides, etc. A volume up/down key 289 and a channel up/down key 290 permit the user to set the volume level and to select television channels. A DVD/VCR keypad 291 allows the user to control a DVD player and/or a VCR. A “Fav” key 292 accesses a favorite channel feature as discussed in greater detail below. An “Info” key 293 can be pressed by a user to access additional information on a particular topic.

It will of course be appreciated that the function(s) associated with the various keys and buttons of the remote controls described above may vary depending on the state of television 200 (e.g., watching television, moving through menus, making menu selections, etc.).

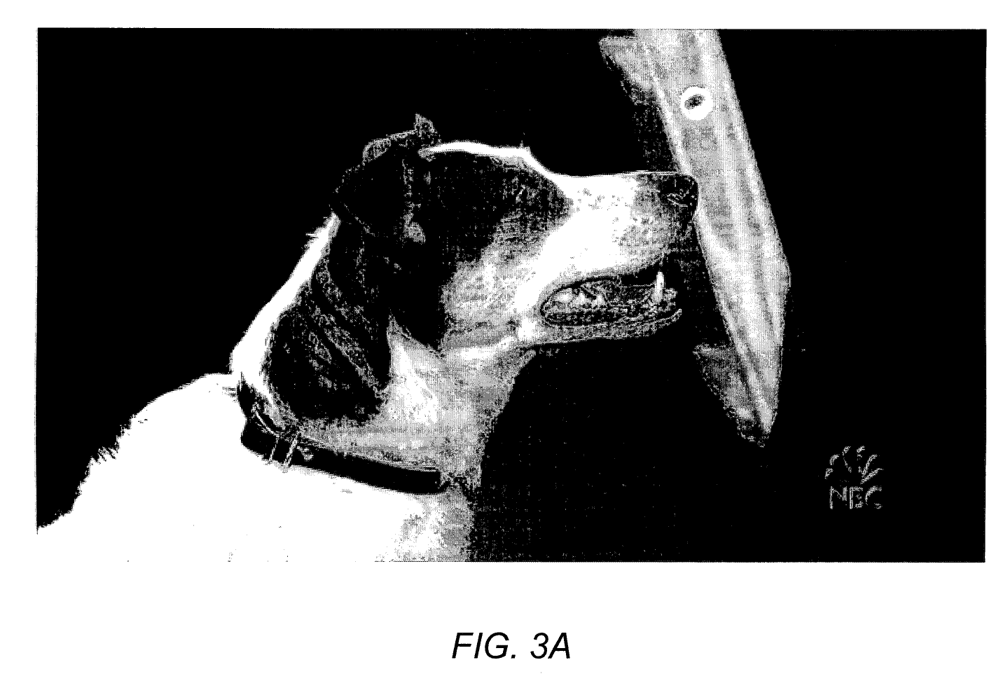

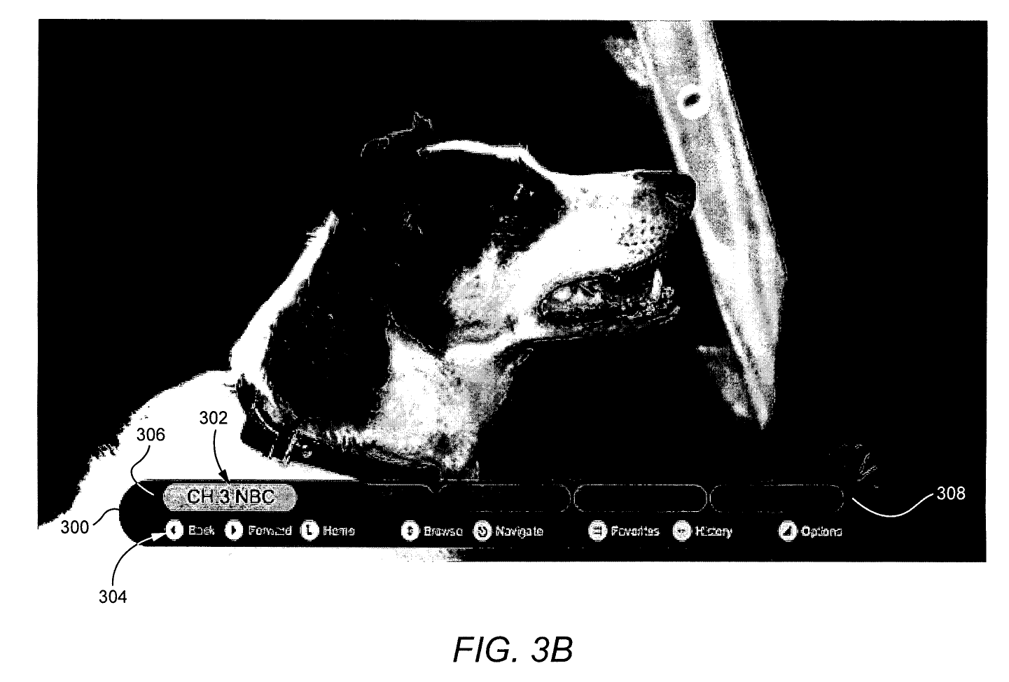

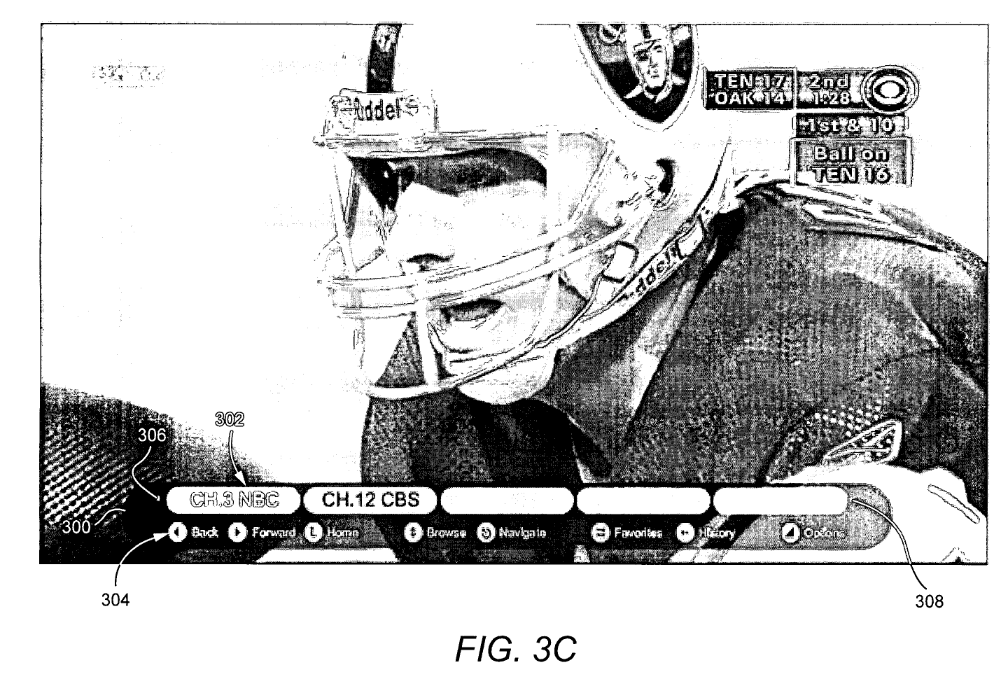

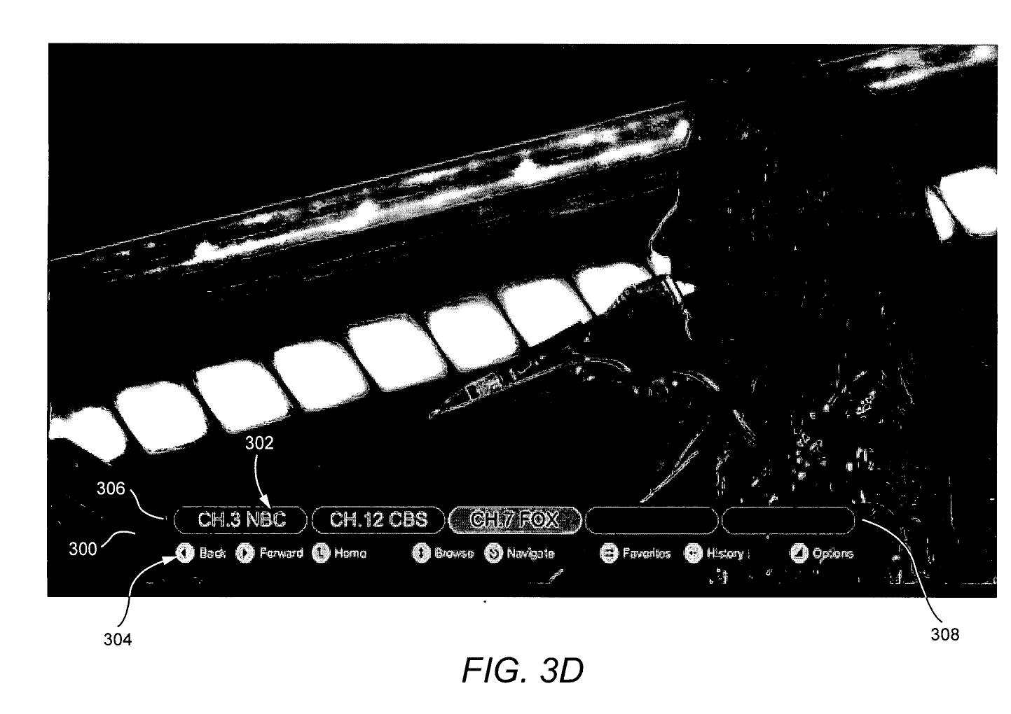

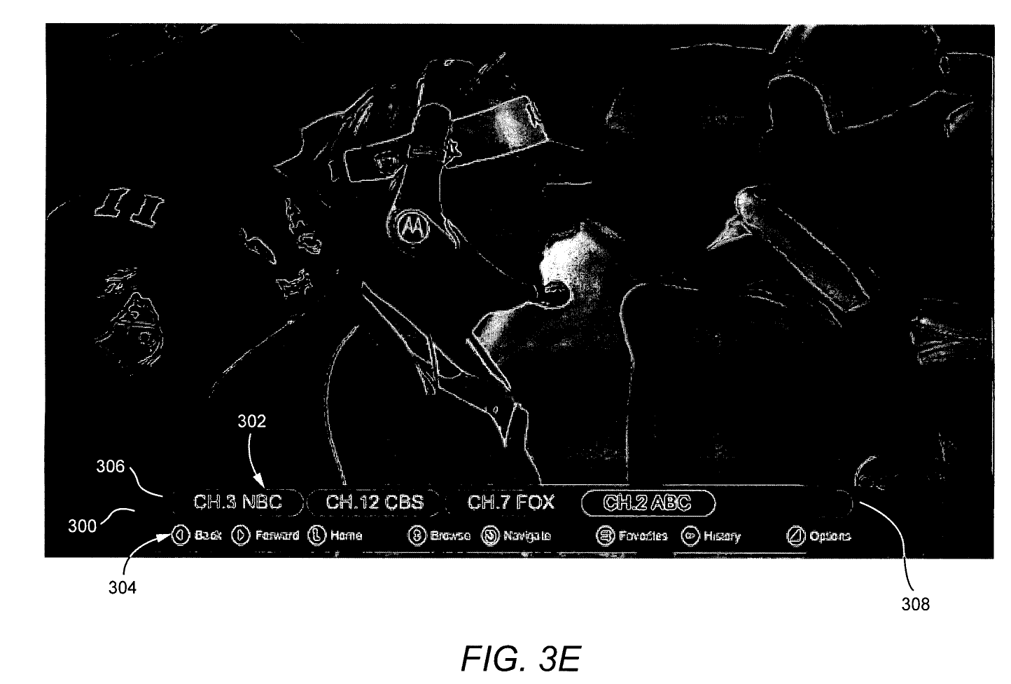

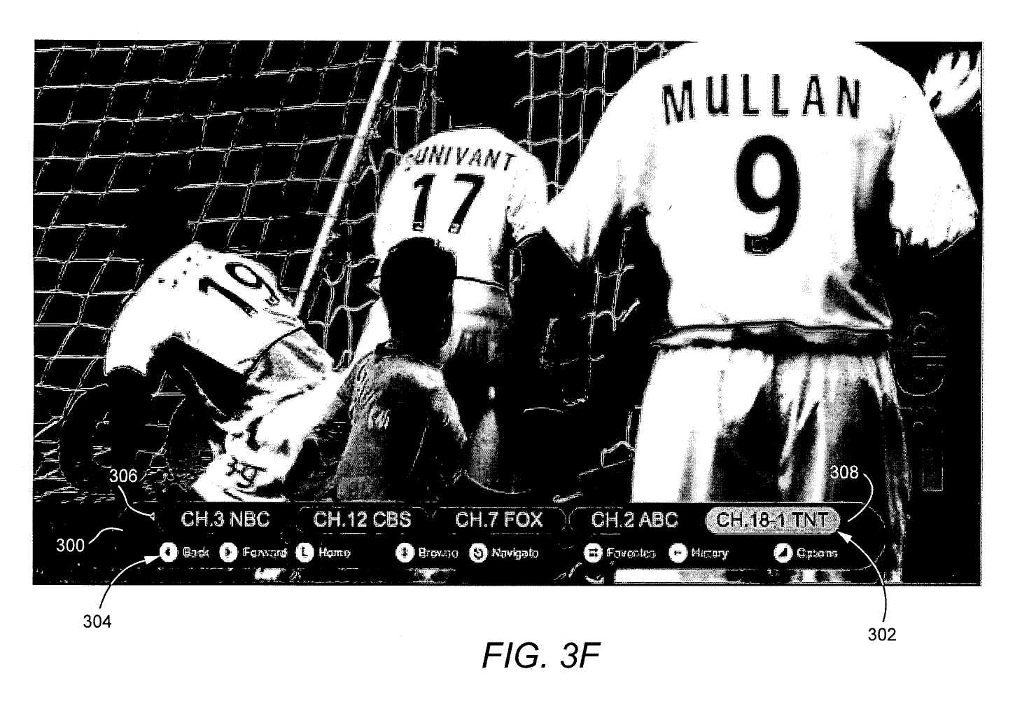

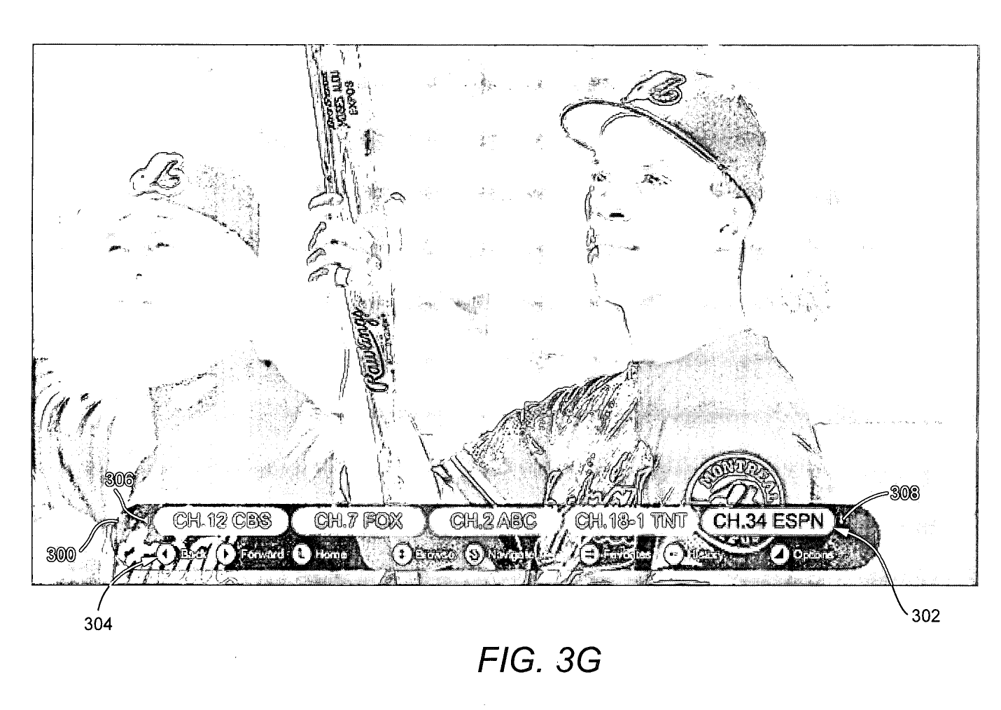

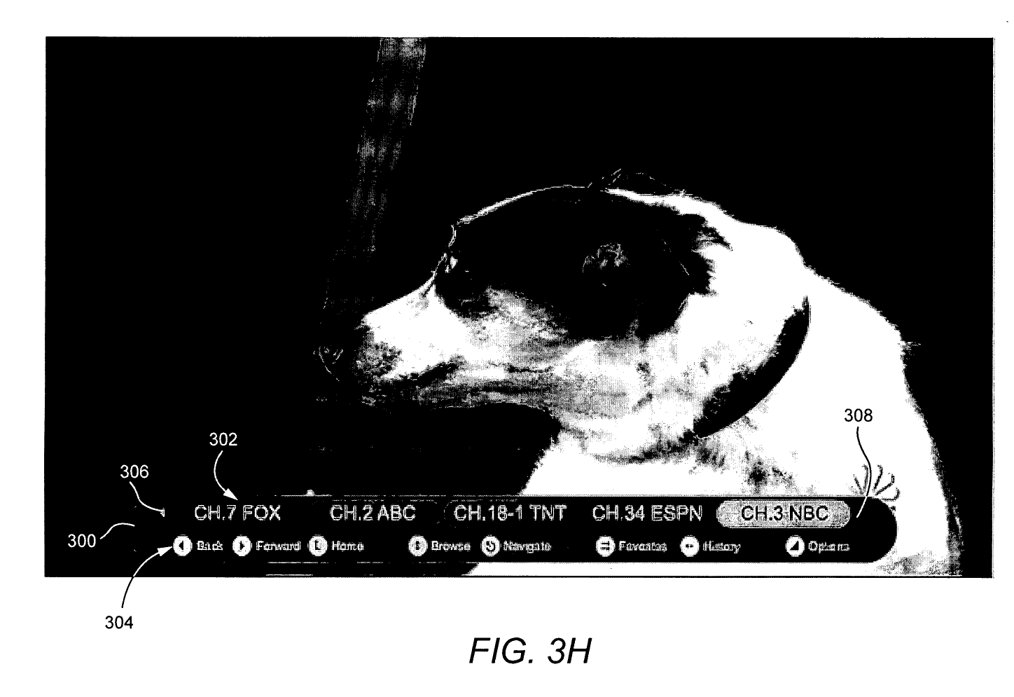

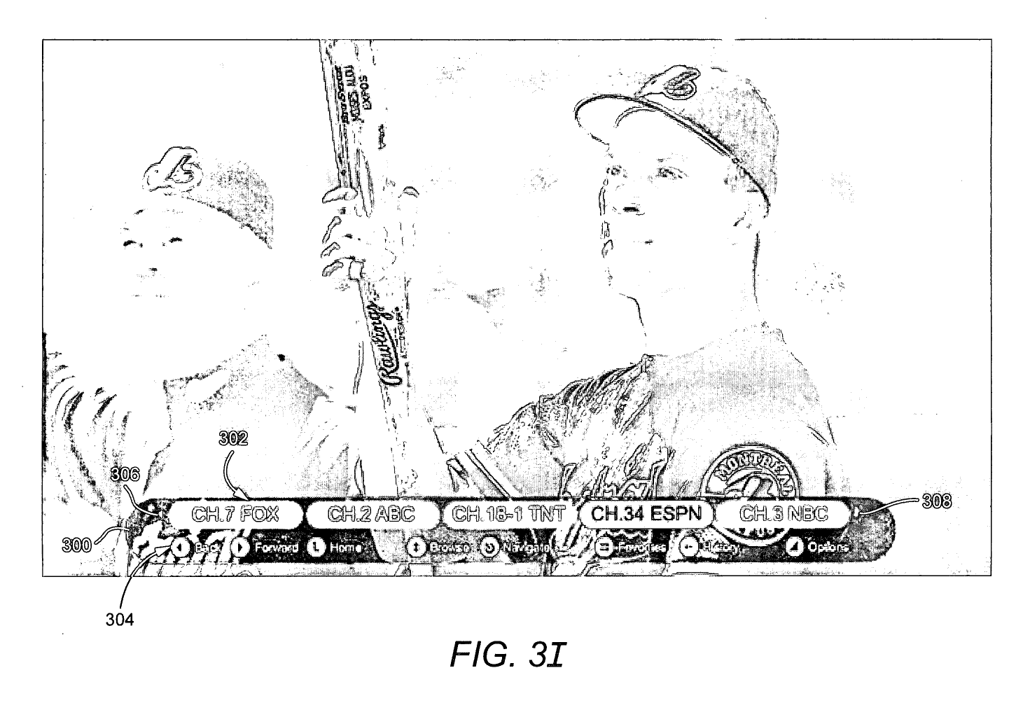

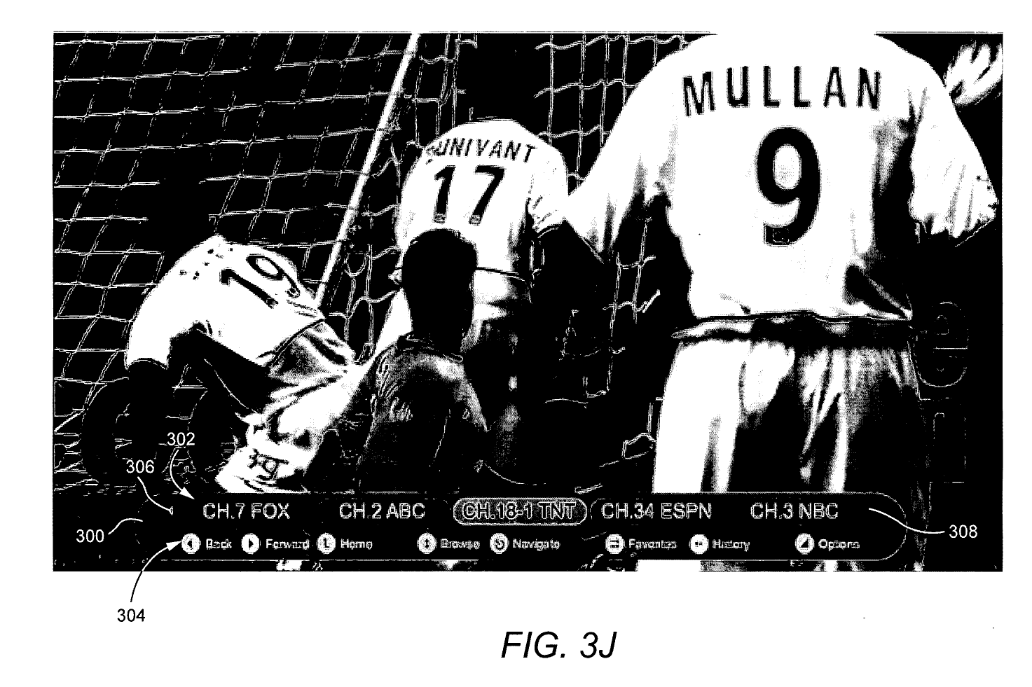

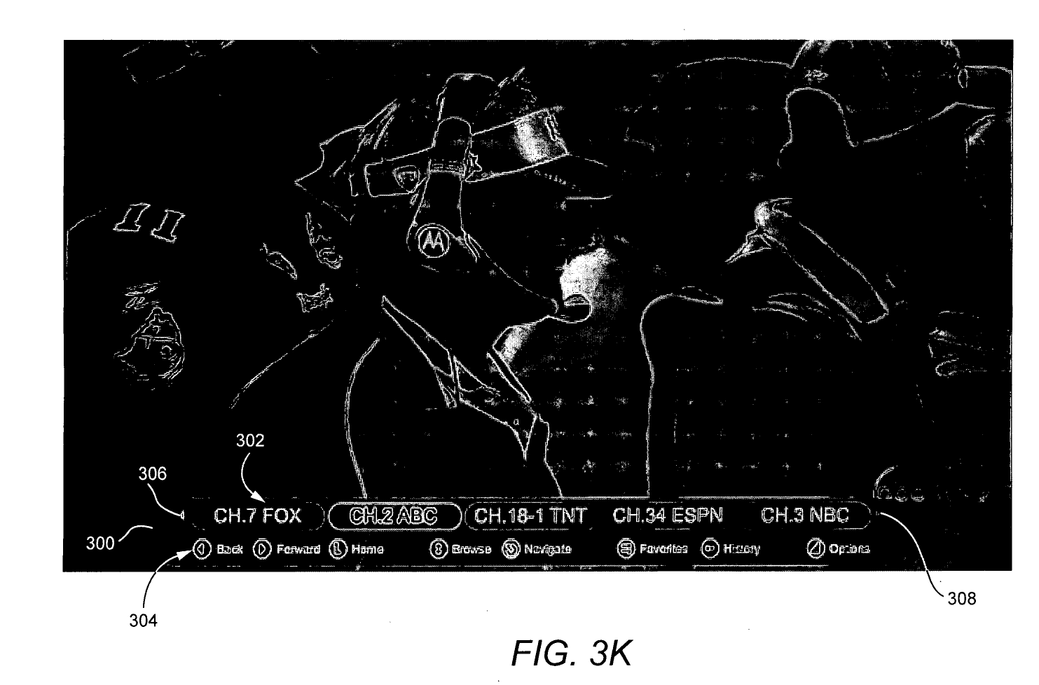

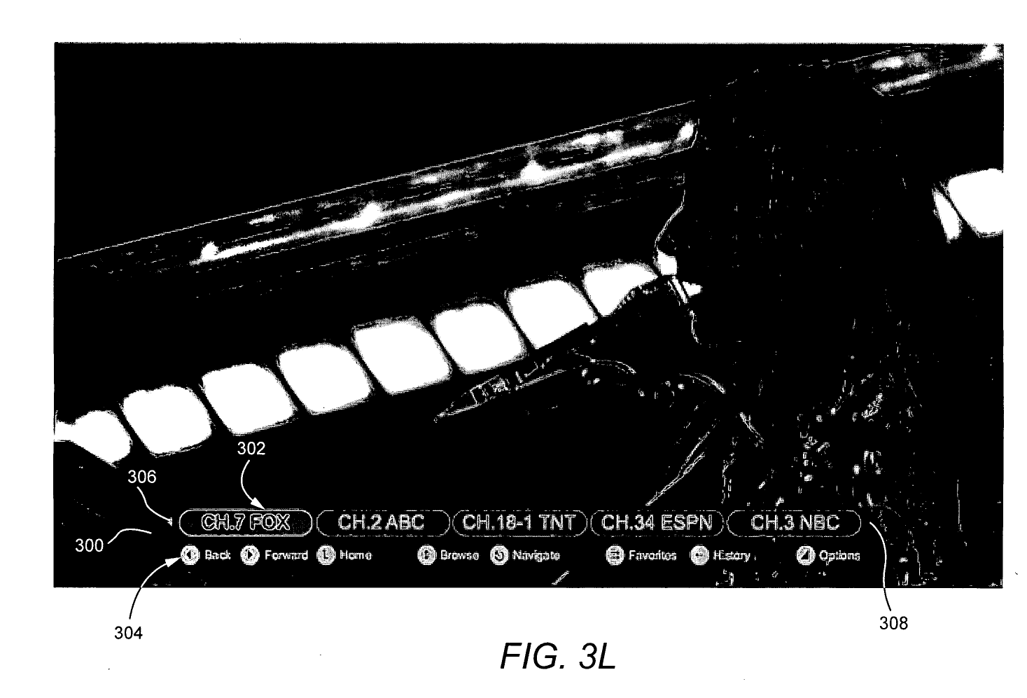

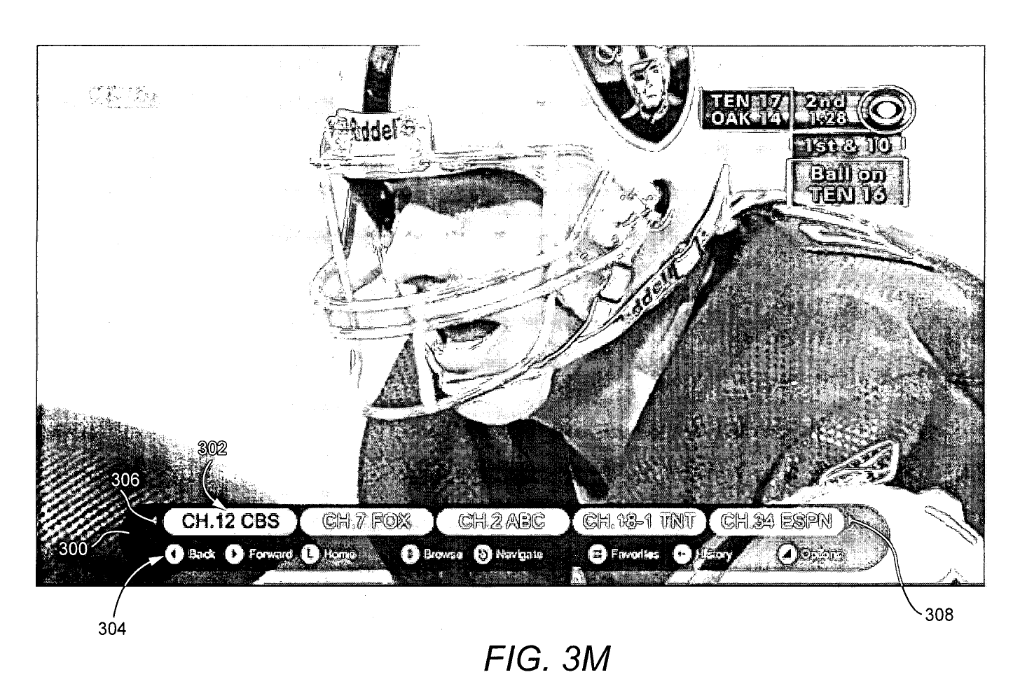

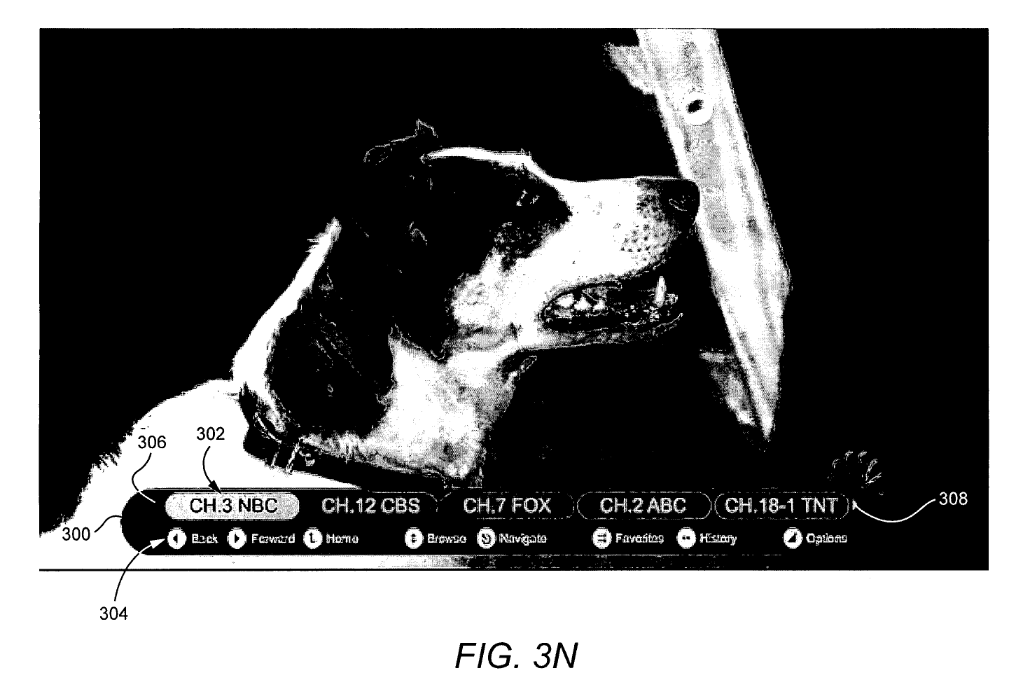

FIGS. 3A-3O are screen displays for explaining an example channel browser feature of the user interface.

FIG. 3A shows a television tuned to a particular channel (e.g., channel 3). The user may invoke the channel browser functionality by pressing one or more specified keys. For purposes of this discussion, it will be assumed that the channel browser functionality is invoked by pressing enter key 252 on remote control 250. When the enter key is pressed, channel browser bar 300 is displayed on the television screen as shown in FIG. 3B. In FIG. 3B, channel browser bar 300 is positioned in the lower center portion of the television screen. However, the interface is not limited in this regard and channel browser bar 300 may be otherwise positioned, for example in accordance with the operating program of the television or a user-specified preference. In this example, channel browser bar may be removed from the screen after a predetermined time period elapses with no further input from the user. The channel browser bar may also be displayed for a predetermined period of time whenever a user changes channels. Also, although channel browser bar 300 is shown in FIG. 3B as being overlaid onto the displayed video, the operating program may be configured to shrink or reduce the video display area (e.g., to provide a space at the bottom of display screen) and to display the browser bar in the space provided by the shrinking or reducing.

Channel browser bar 300 includes a channel list 302 and various user prompts generally shown as 304. These prompts include text and icons to assist a user in interacting with the interface. Thus, as explained below, to move “Back” in the channel list, the left arrow key 254d of remote control 250 is pressed and to move “Forward” in the channel list, the right arrow key 254b of remote control 250 is pressed. For example, with reference to FIG. 3B, the prompt for moving “Back” in the channel list includes an icon for the remote control key to be pressed and text indicating what action takes place when the remote control key corresponding to this icon is pressed. The prompts shown in FIG. 3B include “Back”, “Forward”, “Home”, “Browse”, “Navigate”, “Favorites”, “History” and “Options.” The functions associated with these prompts will be discussed in greater detail below. In some example implementations, the prompt associated with a current key press may be highlighted in some way to provide feedback to the user. Thus, when the user presses the “Browse” key on remote control 250, the corresponding prompt may be highlighted in some fashion.

In FIG. 3B, channel list 302 shows that “CH. 3 NBC” is the current channel, and that there are no other channels in the list. In this example, the channels in the channel list are identified by channel number and station call letters. In other implementations, the channels may be identified by channel number or station call letters alone. In still other implementations, icons associated with the channels may be used. Arrows 306, 308 to the left and right respectively of the channel list 302, when active, show that there are channels in the list that are out of view.

When the user tunes to a new channel, that channel is added to the channel list 302. In FIG. 3C, the user has tuned to channel 12 and this channel has been added to the channel list 302 to the right of the previously tuned channel (i.e., channel 3). The currently tuned channel (i.e., channel 12) is highlighted in the channel list. FIGS. 3D-3F illustrate the effect on the channel list of successively tuning to channels 7, 2, and 18-1. The channel list 302 of FIG. 3F is full, that is, it contains the maximum number of channels that may be displayed in the list at any one time, in this case, five. Of course, this number may be varied in accordance with the operating program of the television or a user-specified preference. In FIG. 3F, the right-most channel in the list (i.e., the currently tuned channel 18-1) is highlighted.

FIG. 3G shows what happens when a new channel is tuned when channel list 302 is full. With reference to FIG. 3G, the user has tuned to channel 34 and this new channel has been added to channel list 302. The highlight remains on the right-most channel in channel list 302 and the other channels in the channel list are shifted to the left. Note that the previously left-most channel in FIG. 3F (i.e., channel 3) is no longer visible and that the left arrow key 306 is now active, indicating that the channel list contains channels to the left of channel 12.

FIG. 3H shows what happens if the viewer tunes to channel 3 again. With reference to FIG. 3H, channel 3 is added to the end of the channel list and is highlighted as the currently tuned channel.

The user may then tune to the channels in the channel list using left and right arrow keys 254b, 254d on remote control 250. For example, if the user presses and releases the left arrow key in the FIG. 3H example, the television tunes back to channel 34 and channel 34 is highlighted in channel list 302 as shown in FIG. 3I. Pressing and releasing the left arrow key again tunes the television to channel 18-1 and channel 18-1 is highlighted in channel list 302 as shown in FIG. 3J. Pressing the left arrow key again tunes the television to channel 2 and channel 2 is highlighted in channel list 302 as shown in FIG. 3K. Pressing the left arrow key yet again tunes the television to channel 7 and channel 7 is highlighted in channel list 302 as shown in FIG. 3L. Pressing the arrow key again tunes the television to channel 12 and shifts the channels in channel list 302 to the right so that channel 12 is visible in the channel list and highlighted as the current channel as shown in FIG. 3M. Note that in FIG. 3M both the left and right arrows 306, 308 are now active. Finally, pressing the left arrow key one more time tunes the television to the first channel in the channel list, channel 3, and causes this channel to be highlighted in the channel list as shown in FIG. 3N. Once back to the first channel, the left “more channels” arrow 306 becomes inactive to show that there are no more channels to the left of the currently tuned channel.

In the description with respect to FIGS. 3G-3N, the user sequentially steps through channels in channel list 302 to the left of currently tuned channel by pressing and releasing the left arrow key on remote control 250. Similarly, the user can sequentially step through channels in channel list 302 to the right of the currently tuned channel by using the right arrow key of remote control 250.

The operating program may be configured to permit the user to hold down or rapidly press the arrow keys to skip multiple channels in channel list 302 to proceed more quickly to a desired channel. Thus, for example, if the user viewing the display of FIG. 3N wants to tune to channel 18-1, he/she may hold down the right arrow key 254b of remote control 250. This will cause the highlight to sequentially step through the channels in the channel list without tuning to the highlighted channel. When the highlight reaches the desired channel (e.g., channel 18-1), the user may release the arrow key and the television will tune to channel 18-1 as shown in FIG. 3O. As noted, in this example implementation, when the user is holding down the arrow key to proceed quickly to a desired channel, the television does not tune to the highlighted channel. Tuning occurs only when the user releases the arrow key when the highlight is positioned on the desired channel.

The channel list is stored in memory 220 and may be implemented in a variety of ways. For example, the operating program can generate a channel list which is stored in memory 220. A channel is added to the list when the user tunes to a channel by direct channel number entry, from a program guide, etc. A pointer or other indicator can be used to identify the currently-tuned channel. When the channel bar is displayed, the operating program is responsive to user inputs supplied via the left and right arrow keys to move the pointer within the channel list and, as appropriate, tune to the pointed to channel. Other implementations are also possible and may involve, for example, a “channel back list” for channels that are accessible using the left arrow key of remote control 250 and a “channel forward list” for channels that are accessible using the right arrow key of remote control 250.

The maximum length of the channel list stored in memory 220 is configurable either in accordance with the operating program or a user-specified preference. The list may be maintained during a single viewing session (i.e., from television turn-on to television turn-off) or may be maintained to provide an initial list for a subsequent viewing session. For example, when the user turns the television on, he/she may be prompted via a display on the television as to whether the channel list from the previous session should be loaded or cleared. While the above description is made with reference to a single channel list, it is also possible to maintain channel lists for a plurality of different users or groups of users. These plural channel lists may also be maintained to provide an initial list for a subsequent viewing session.

The user may also be given an option to save particular channel lists for later use. For example, a football fan may generate a particular channel list while watching football games on a Sunday afternoon and wish to save this list for use on subsequent Sundays. This saved list may constitute an initial channel list that is modified during a given session on these subsequent Sundays and the user may choose to save the modified list or revert back to the previously saved list.

The operating program may also be arranged to automatically generate channel lists based on user viewing habits and/or current time. For example, if a user frequently watches movies, the operating program may, with reference to theme information contained in downloaded electronic program guide data, generate a channel list that includes channels on which movies are currently being shown. Similarly, lists could be generated based on sports, situation comedies, children's shows and the like.

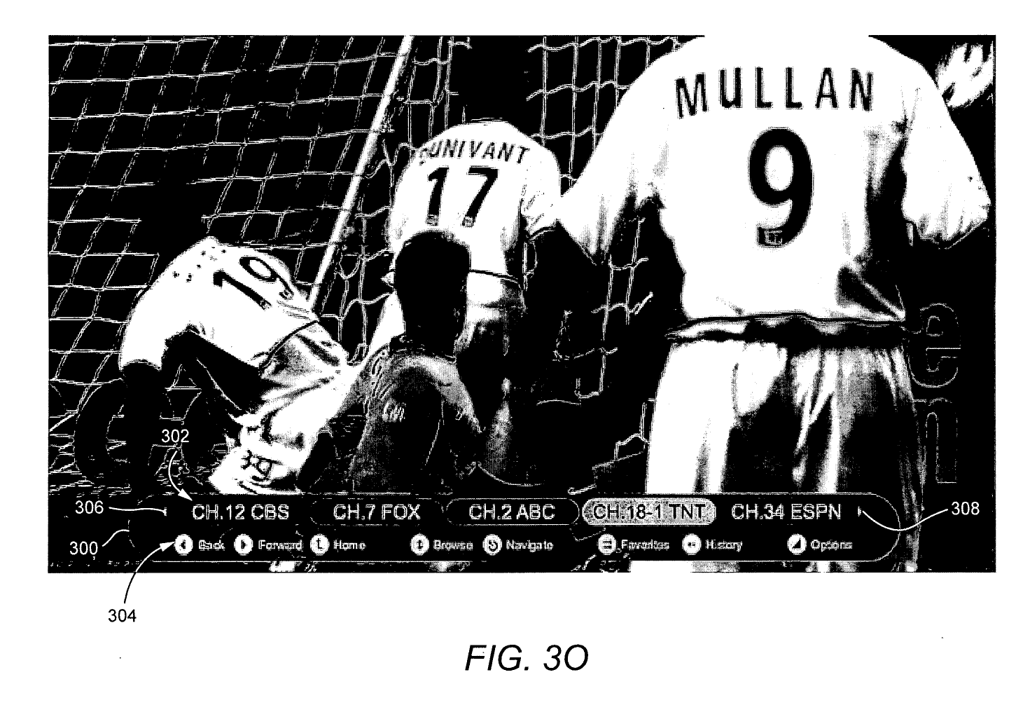

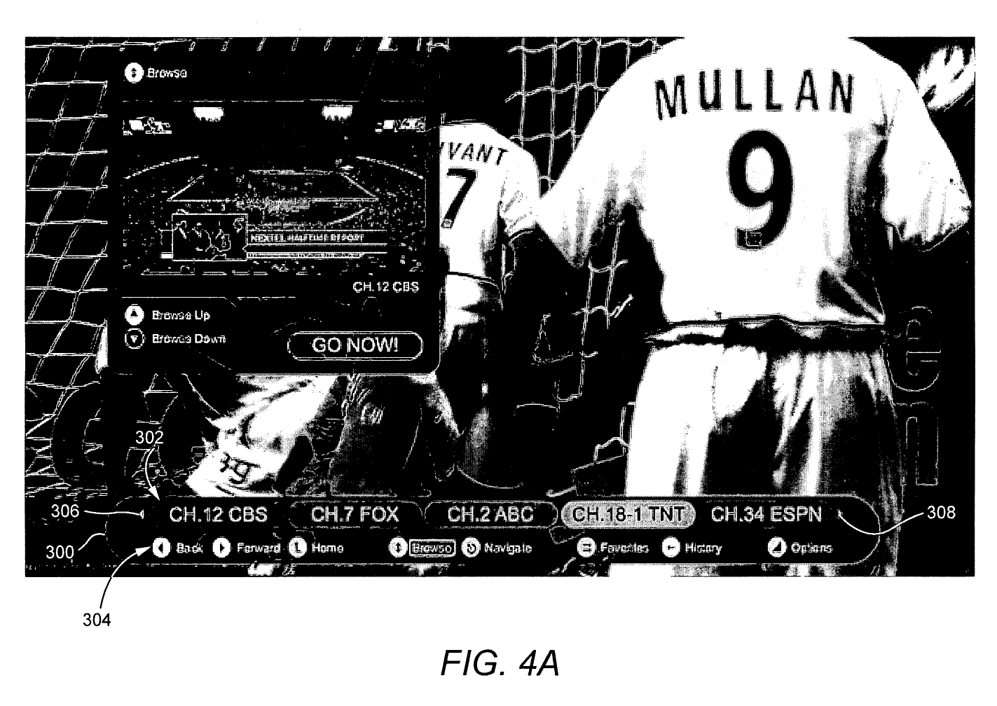

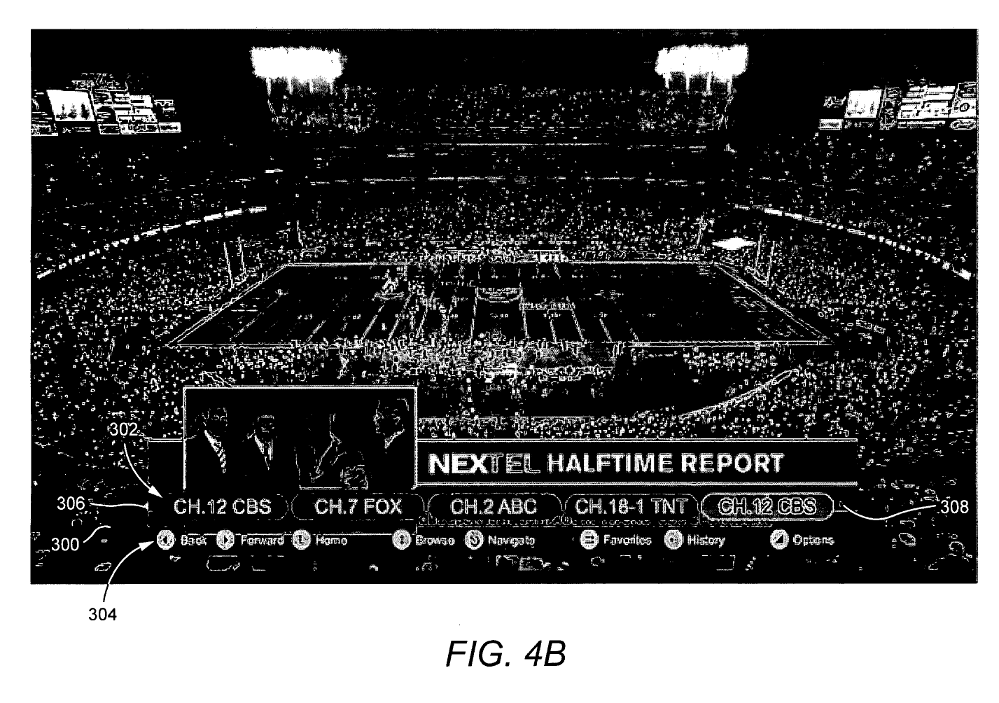

The “BROWSE” feature will be explained with reference to FIGS. 4A and 4B.

A user viewing the display of FIG. 30 may invoke the “BROWSE” feature by pressing one or more specified keys. In this regard, although FIG. 2 shows a dedicated BROWSE key 258, it will be apparent that the BROWSE feature may be otherwise invoked such as by pressing a combination of keys each of which is normally individually associated with other features. For purposes of this discussion, it will be assumed that remote control 250 includes a dedicated BROWSE key 258 that is pressed by the user to invoke the BROWSE functionality.

When BROWSE key 258 is pressed, a browse window 400 is overlaid onto the display of the currently tuned channel as shown in FIG. 4A and sequentially steps (tunes) through the tunable channels. Note that the “Browse” prompt has been highlighted, providing feedback to the user that the Browse feature has been invoked. In an example implementation, the browsing begins at the lowest tunable channel. In other implementations, the browsing may begin at some other channel determined by the operating program or a user-specified preference. When a desired channel is seen in the browse window 400, the user may press the enter key on remote control 250 to select and tune to that channel. When a desired channel (e.g., channel 12) is selected and tuned, the user can watch the desired channel in full screen as shown in FIG. 4B.

With reference to channel list 302, the previous channel after 18-1 (i.e., channel 34) has been replaced by channel 12 and channel 12 becomes the highlighted channel. Channel 34 and any other channels after channel 34 in the channel list are shifted to the right. The user viewing the screen of FIG. 4B may, for example, press and release the left arrow key on remote control 250 to go back to channel 18-1.

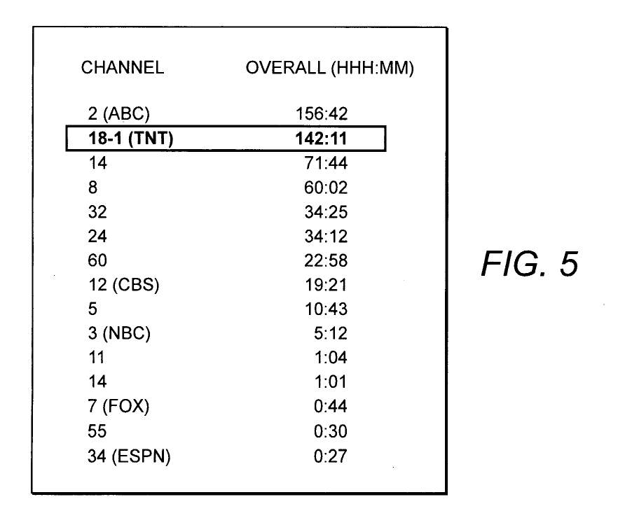

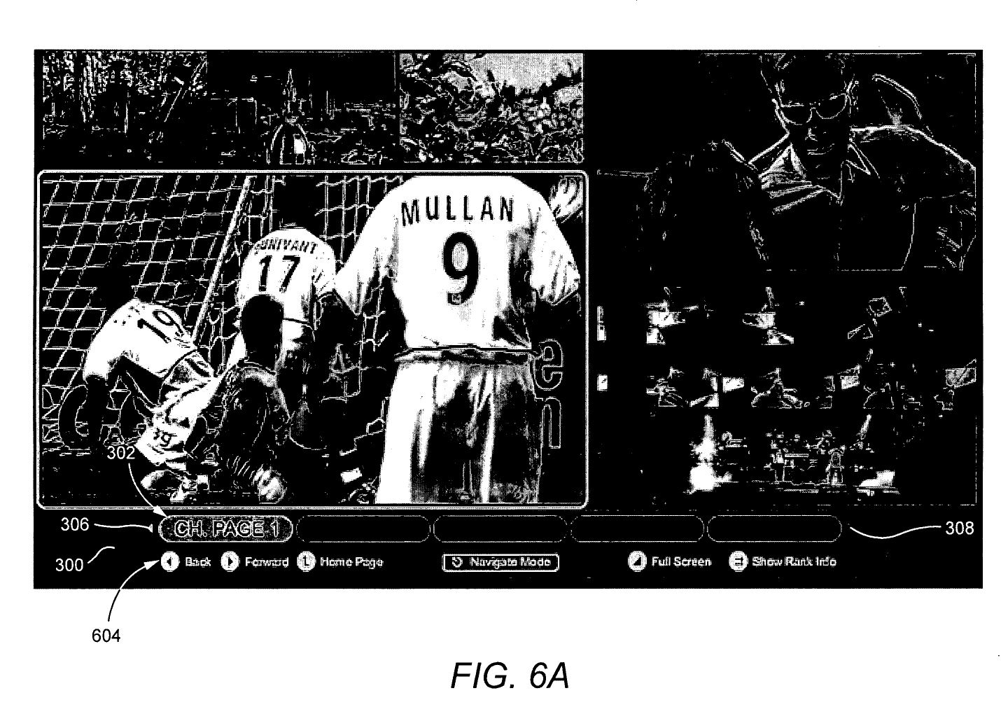

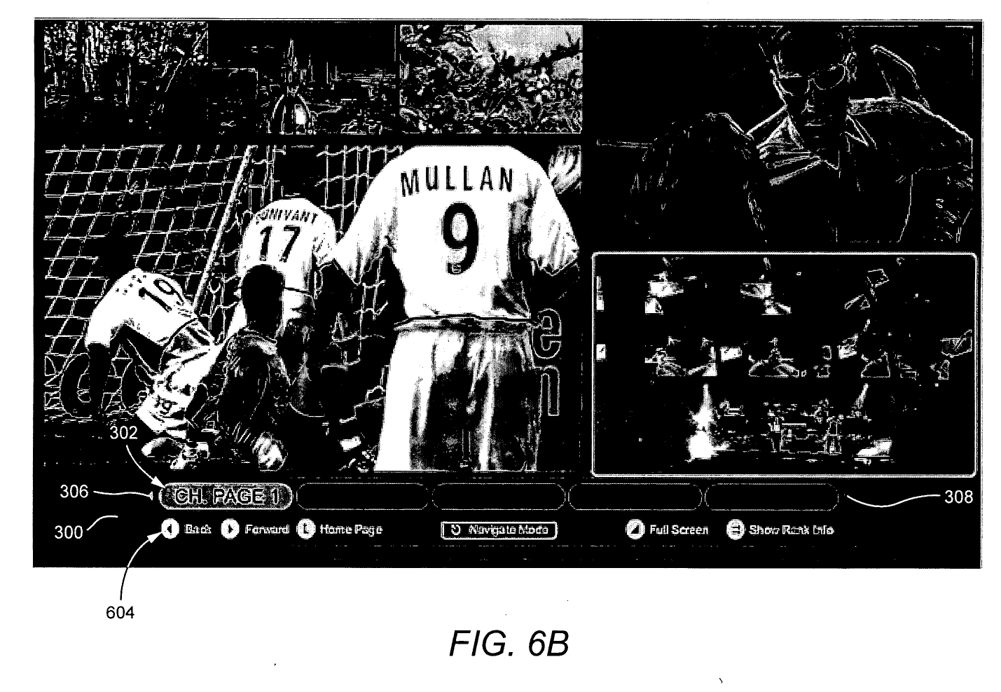

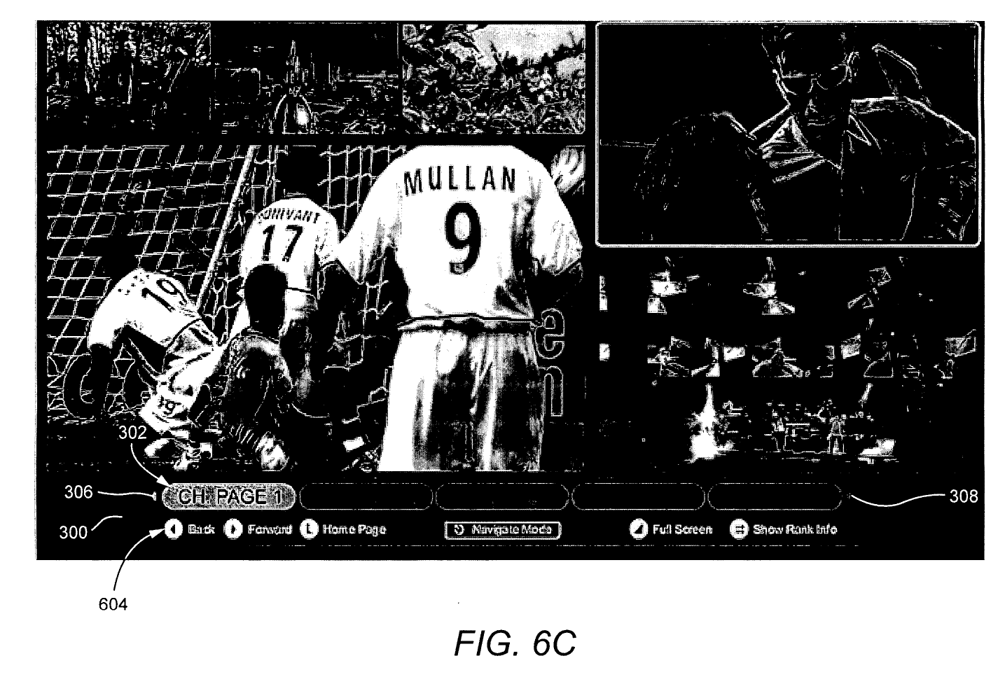

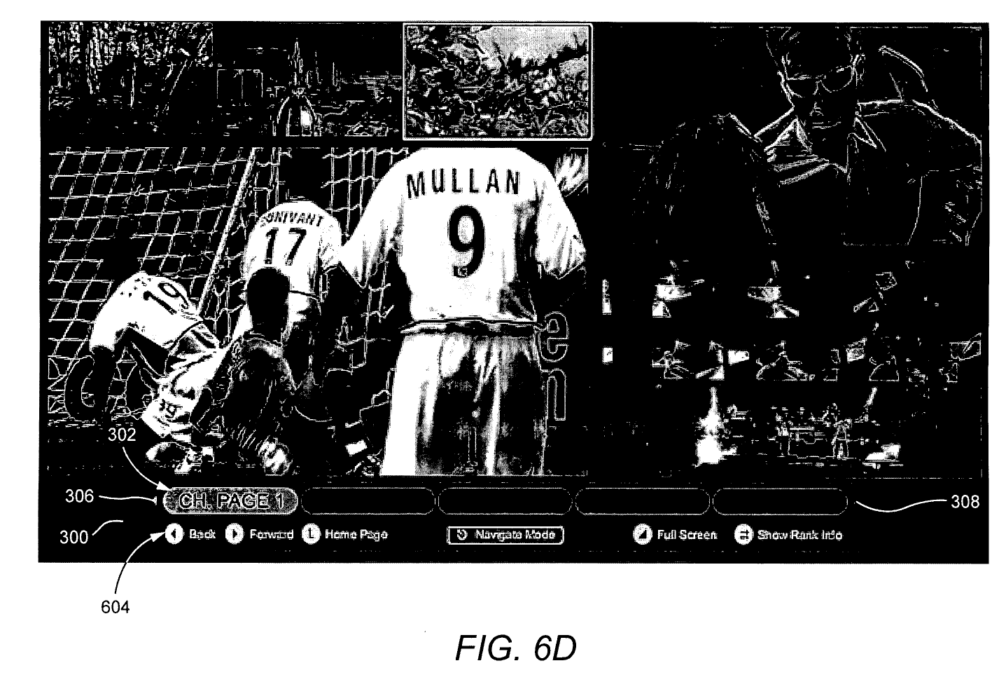

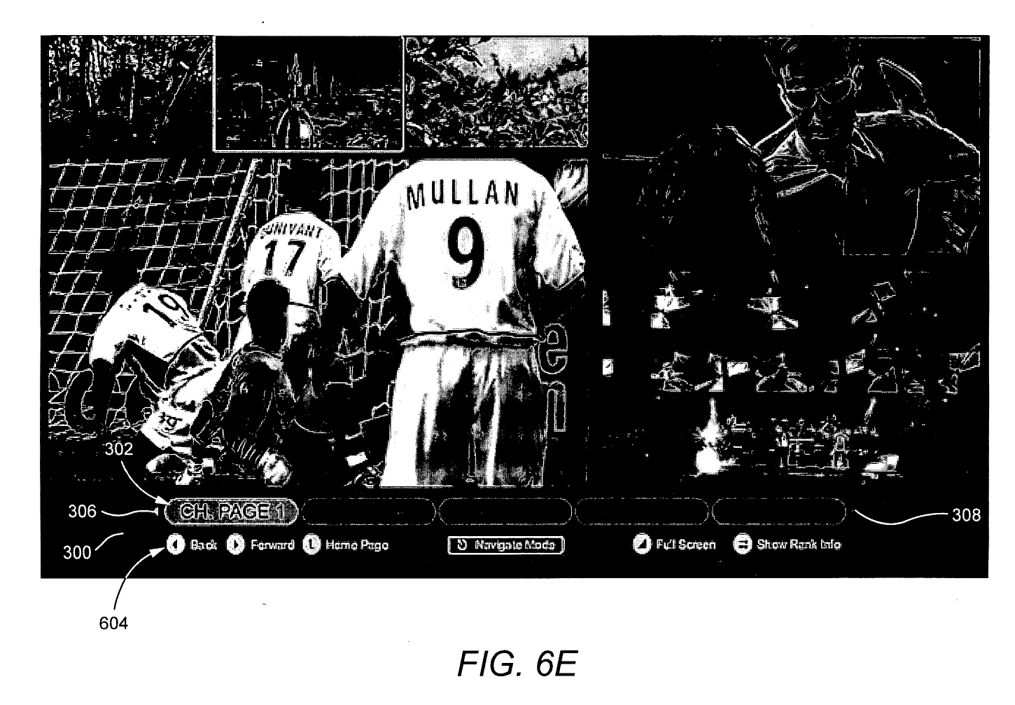

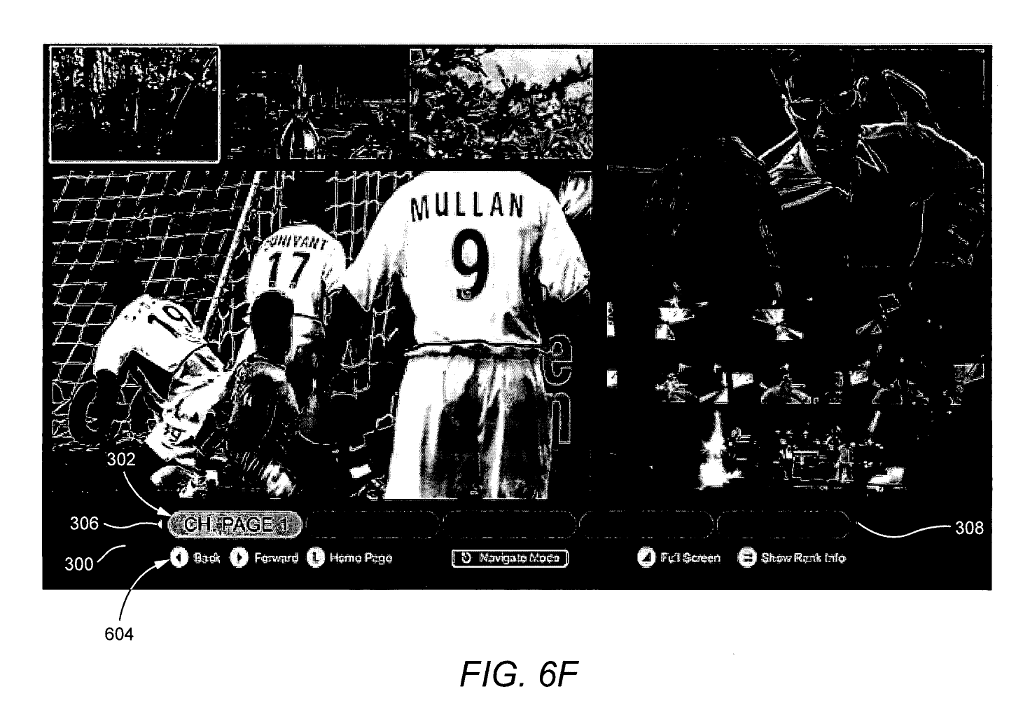

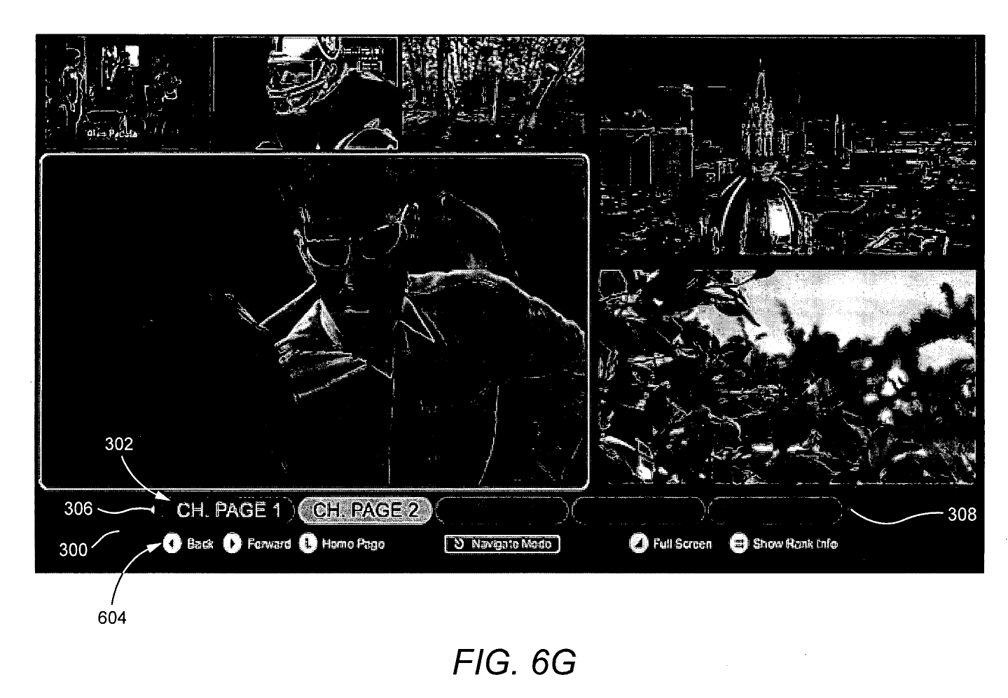

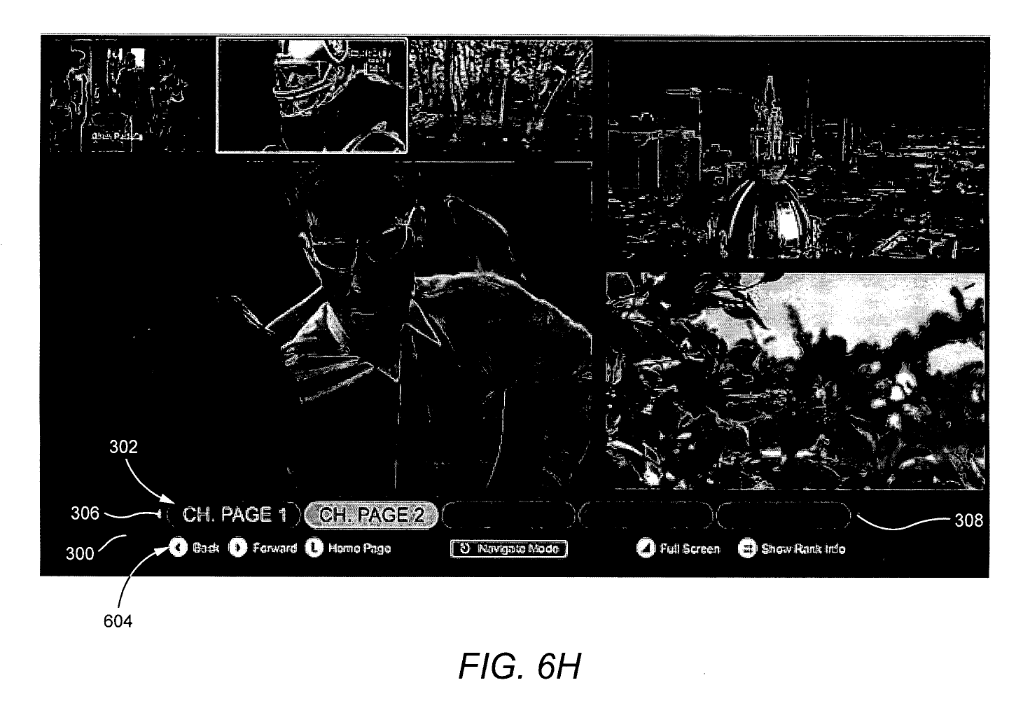

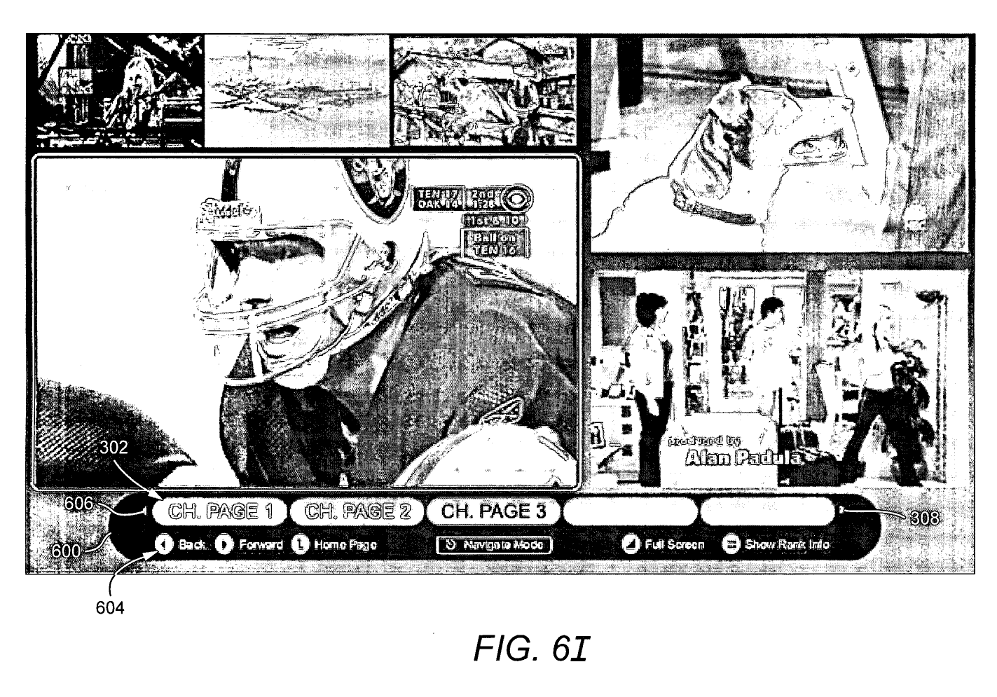

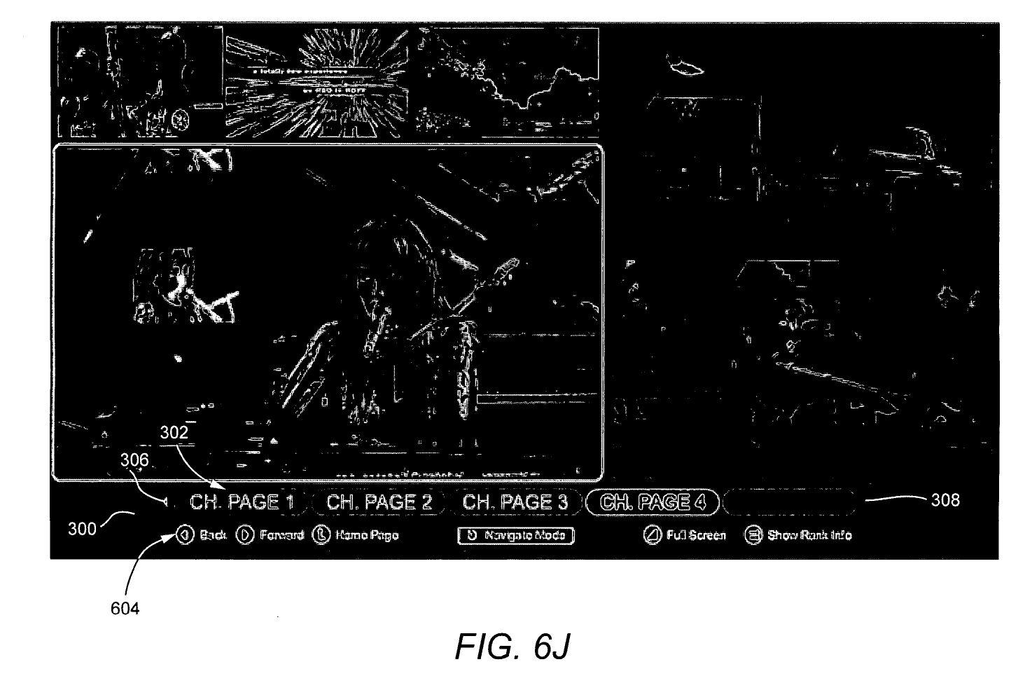

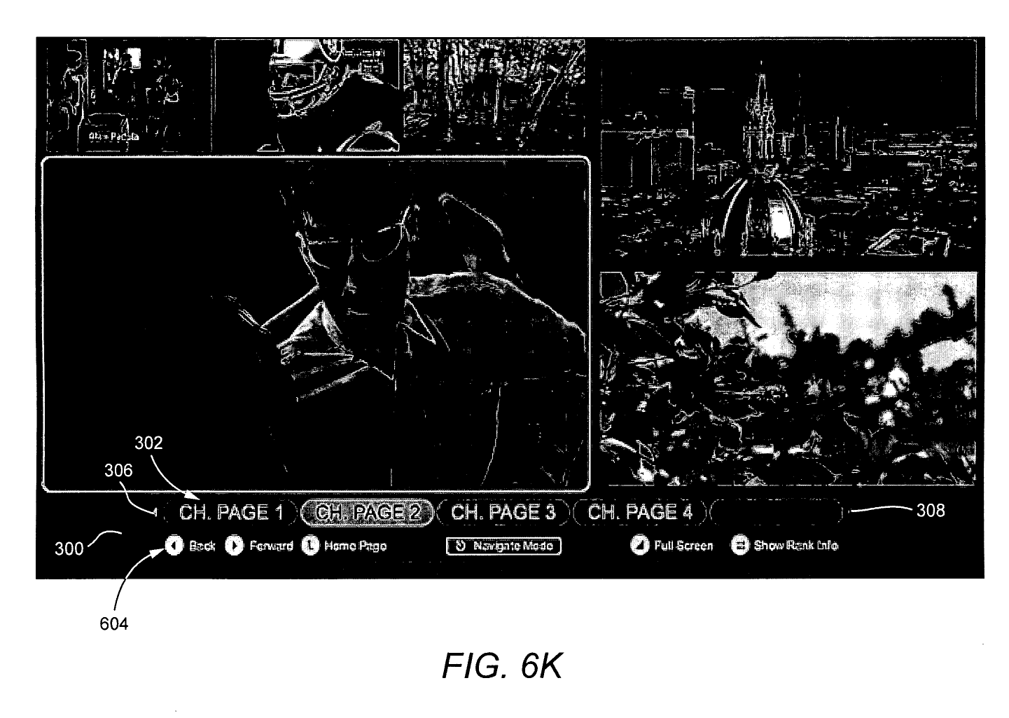

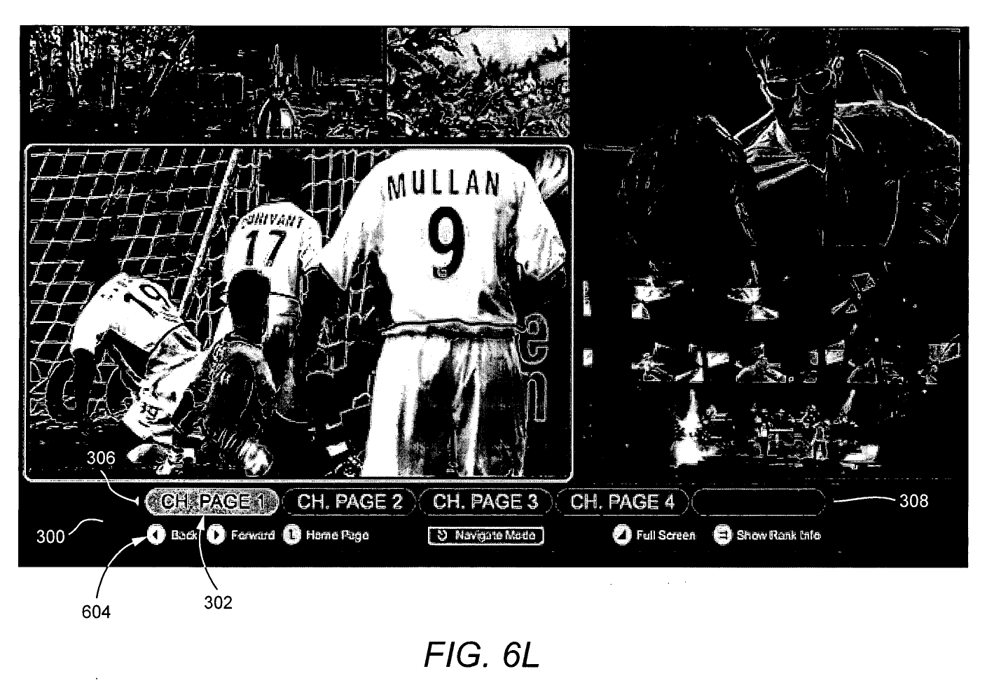

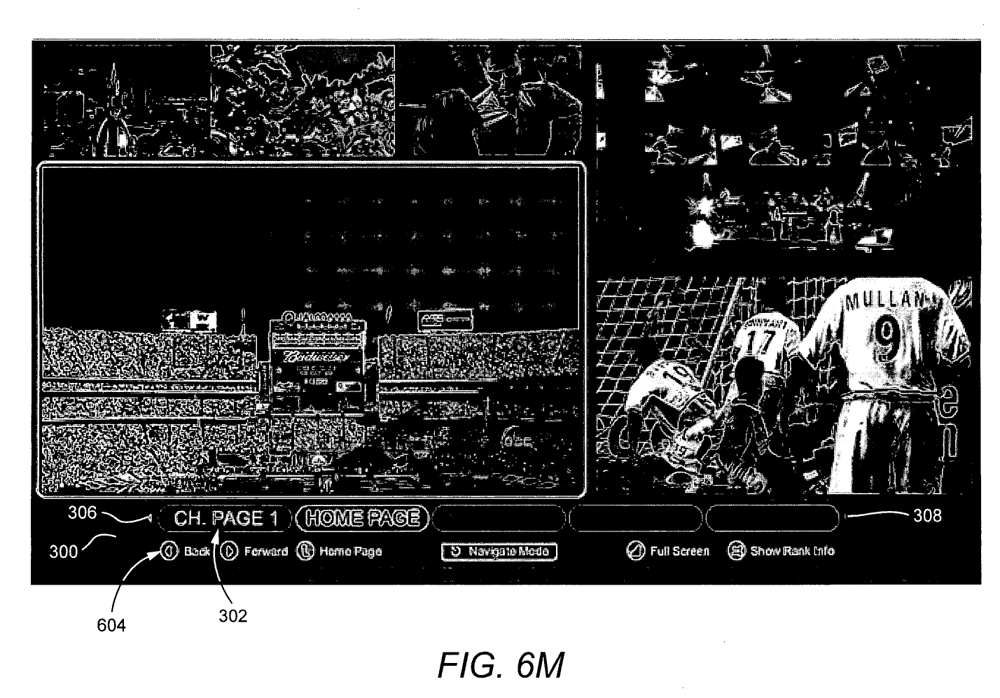

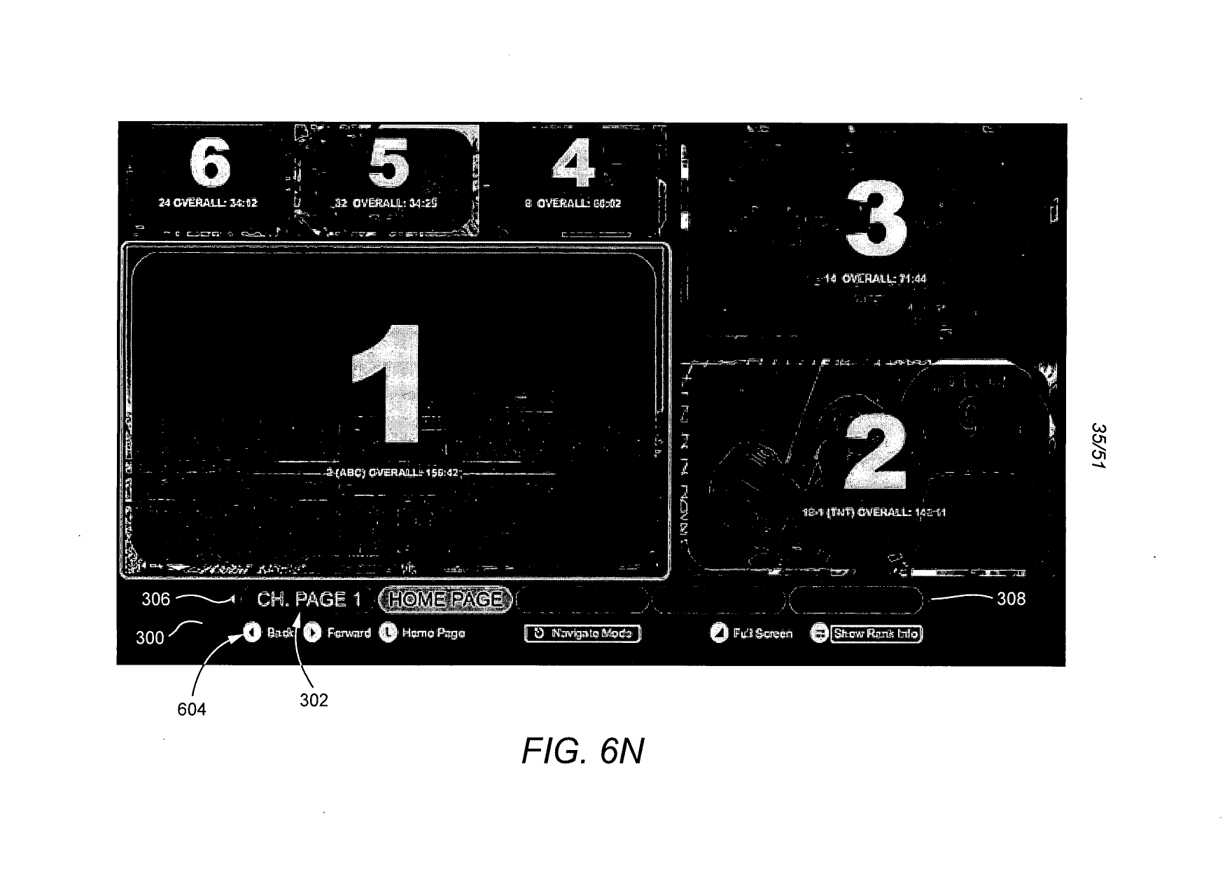

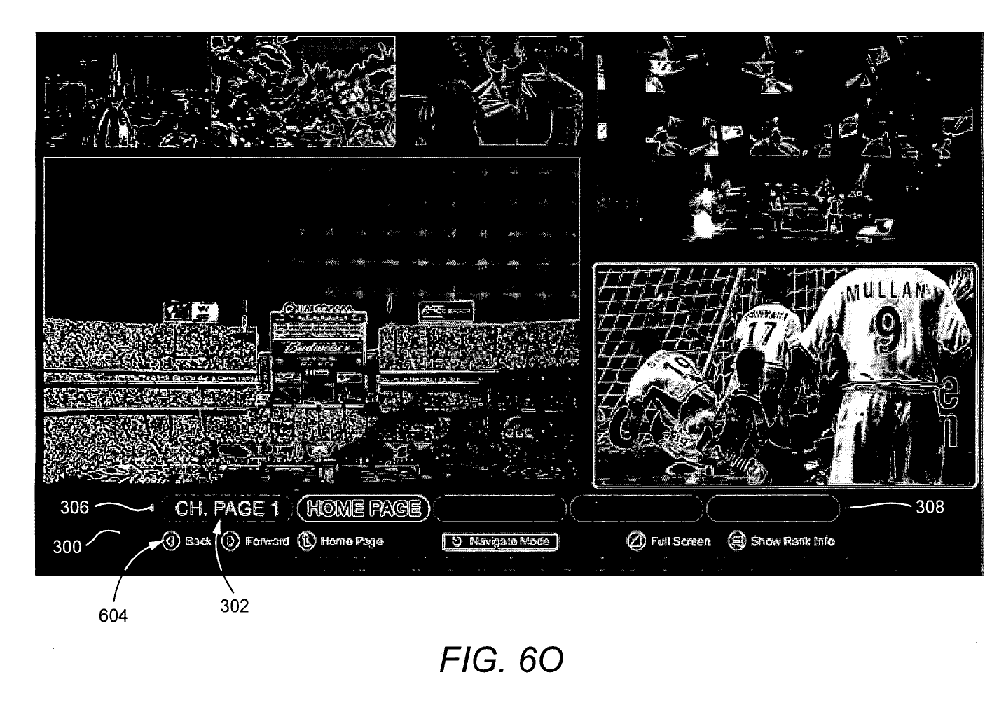

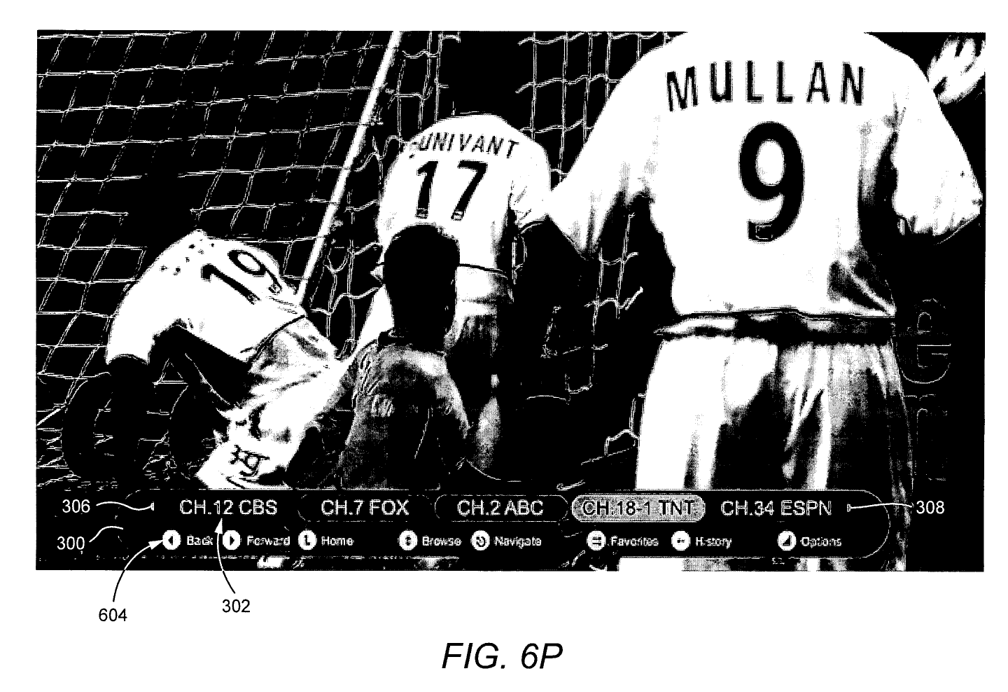

The NAVIGATE feature will be explained with reference to FIGS. 5 and 6. This feature is useful, among other things, for channel jumping and channel rankings.

A user may invoke the NAVIGATE feature by pressing one or more specified keys. In this regard, although FIG. 2 shows a dedicated NAVIGATE key 260, it will be apparent that the NAVIGATE feature may be otherwise invoked such as by pressing a combination of keys each of which is normally individually associated with other features. For purposes of this discussion, it will be assumed that remote control 250 includes a dedicated NAVIGATE key 260 that is pressed by the user to invoke the NAVIGATE functionality.

Reference is made to the example channel ranking list of FIG. 5 which shows channels ordered by popularity. More specifically, the operating program of the television includes a routine (or routines) for tracking the total time (e.g., in hours and minutes) that each of the tunable channels is watched. The channel ranking list is stored in memory 220 of the television. While the discussion below is with reference to a channel ranking list that tracks overall viewing time for each of the tunable channels received by the television, it will be apparent that this channel ranking list may be replaced or supplemented by channel ranking lists that track viewing for individual users or groups of users (e.g., children, adults, etc.). In this case, the operating program would include a routine or routines that enable identification of the users currently viewing the television (e.g., by entering or selecting names of the users).

The position of channel 18-1 in the ranking list is shown by highlighting. When the NAVIGATE feature is invoked, six channels are shown on the screen as illustrated in FIG. 6A. Note that the user prompts 604 in FIG. 6A include a highlighted indication that the NAVIGATE feature has been invoked. The channels are ordered according to the channel ranking list of FIG. 5 in a counter-clockwise direction. The currently tuned channel is in the largest window. This is because relative to the other channels in the display, the currently tuned channel is the most watched channel. Less-watched channels will always appear in smaller windows, one or more of which may be equal to each other in size. The user can use the arrow keys 254a-d of remote control 250 to select another window (i.e., channel). The channel on the bottom right in this example is the next most-watched channel and pressing right arrow key 254b will move the focus to this channel (i.e., channel 14), which is the next most-watched channel, as shown in FIG. 6B. Up arrow 254a of remote control 250 can be used to navigate to channel 8 and then left arrow key 254d can be used to navigate to channels 32, 24 and 60 as shown in FIGS. 6C-6F, respectively. From the focus on channel 60, down arrow 254c may be used to return the focus back to channel 18-1, as shown in FIG. 6A. In this example, “focus” is shown by a providing box around the channel having focus. Of course, other techniques for showing focus may be used and the interface described herein is not limited in this respect.

Creating a “page” will now be described. As evident in FIGS. 6A-6F, the. viewer has been on channel page 1 as shown in channel page list 602, and no other pages are identified in the channel page list 602. By way of example, assume focus has been moved using the arrow keys of remote control 250 to channel 8 as shown in FIG. 6C. When channel 8 has focus, the user can press enter key 252 to go to a new page in which channel 8 is in the largest window and has focus as shown in FIG. 6G. Note that counter-clockwise, the channels are 8, 32, 24, 60, 12 and 5, i.e., in the order set forth in the channel ranking list of FIG. 5. Pressing up arrow key 254a of remote control 250 moves the focus to channel 12 as shown in FIG. 6H. This channel may be selected by pressing enter key 252 and another page is added to the channel page list as shown in FIG. 6I. As shown in FIG. 6I, channel 12 is in the largest window and has focus. It is the most watched channel among the channels on this page. Another page may be added by pressing the up arrow key and then the left arrow key to navigate to channel 7 and then pressing the enter key. This results in the screen of FIG. 6J.

The user may navigate back to a previously visited page using the arrow keys of remote control 250. For example, by pressing and holding left arrow key 254d, the viewer may return to channel page 2 as shown in FIG. 6K. Pressing and releasing left arrow key 254d takes the user back to channel page 1 as shown in FIG. 6L.

When using the NAVIGATE feature, a user may invoke a “home” feature by pressing one or more specified keys. In this regard, although FIG. 2 shows a dedicated HOME key 256, it will be apparent that the “home” feature may be otherwise invoked such as by pressing a combination of keys each of which is normally individually associated with other features. For purposes of this discussion, it will be assumed that remote control 250 includes a dedicated HOME key 256 that may be pressed by the user to invoke the “home” feature. It is noted that when the user is not using the NAVIGATE feature, the HOME key invokes a HOME feature to be discussed in greater detail below.

Invoking the “home” feature in NAVIGATE takes the user to a home page that shows the most watched channels. Note that the channel having focus is the most watched channel in the channel list of FIG. 5. Also note that since the user entered a new page relative to display of FIG. 6F, it is added to the page list and highlighted as shown in FIG. 6M.

The operating program also provides an information feature that may be invoked by a specified input, for example, to remote control 250. This information is overlaid onto the channel displays on the home page as shown in FIG. 6N and shows rank (i.e., 1, 2, 3, 4, etc.) and total hours and minutes watched for that channel. The rank information will change over time depending which channels are tuned to the most. For example, if channel 8 became the most-watched channel, it would replace channel 2 in the number one position, and the remaining channels would be adjusted accordingly. When the viewer enters the NAVIGATE or “Home” features, a current channel list is used.

As shown in FIG. 60, the user viewer can navigate to a particular channel (e.g., channel 18-1 in FIG. 60) and after pressing enter key 252 on remote control 250, channel 18-1 can be viewed in a full-screen mode as shown in FIG. 6P, thereby exiting the NAVIGATE mode. Because the viewer is still on the same channel in the browse bar, there are no changes to the other channels in the channel list.

The channel list of FIG. 5 is also available to the user in connection with a FAVORITE feature. A user may invoke the FAVORITE feature by pressing one or more specified keys. In this regard, although FIG. 2 shows a dedicated FAVORITE key 262, it will be apparent that the FAVORITE feature may be otherwise invoked such as by pressing a combination of keys each of which is normally individually associated with other features. For purposes of this discussion, it will be assumed that remote control 250 includes a dedicated FAVORITE key 262 that is pressed by the user to invoke the FAVORITE functionality.

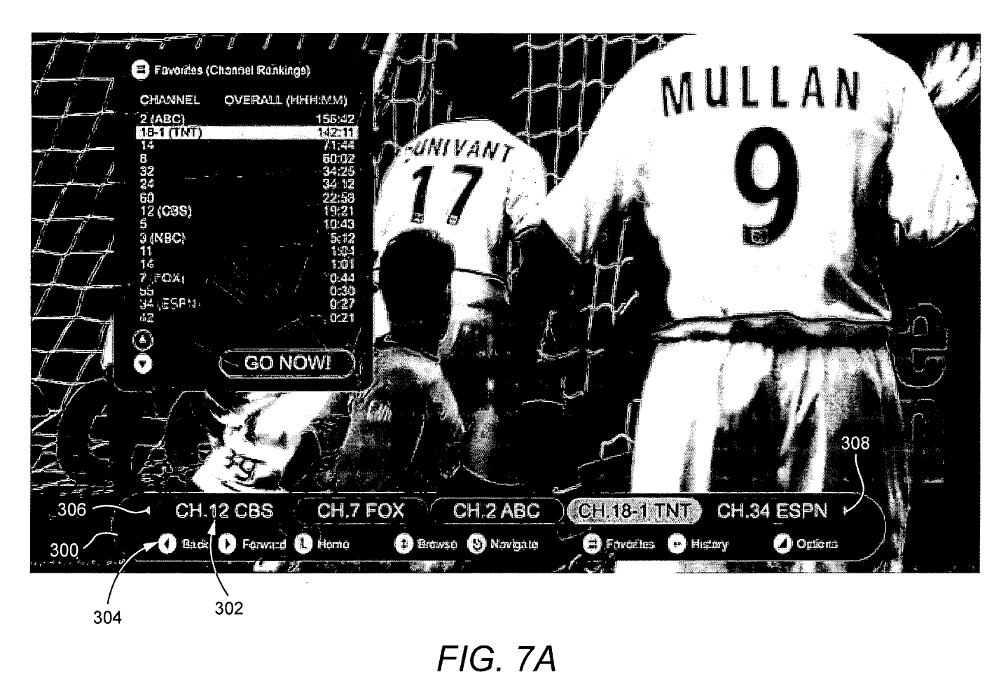

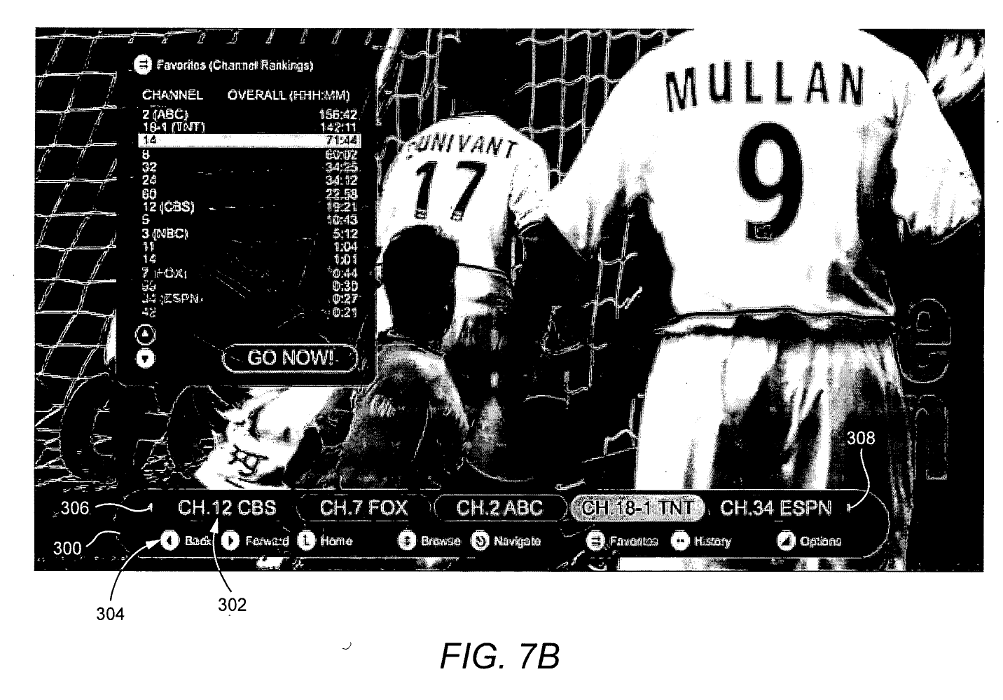

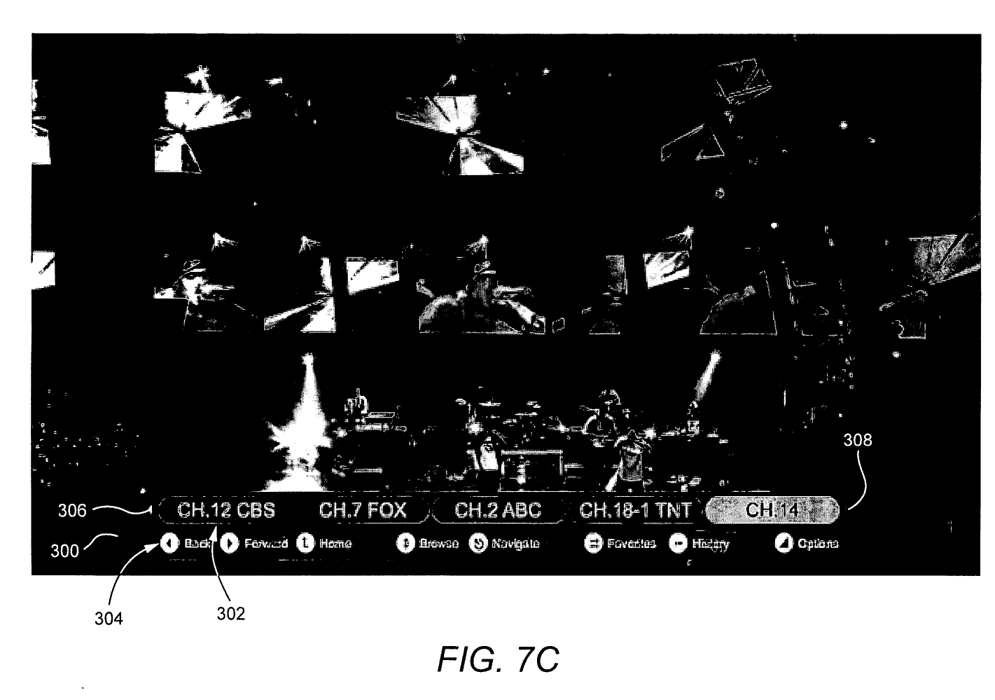

When the FAVORITE feature is invoked, the screen of FIG. 7A is provided. The user can scroll up or down the list of channels, ordered by most-watched. This can be useful to quickly view overall hours and minutes watched, or to tune to a frequently watched channel. Channels can be easily tuned by scrolling to selected channel (e.g., channel 14 in FIG. 7B) using the down arrow and then pressing enter to go to the new channel as shown in FIG. 7C. Note that channel 14 has been added to the end of the channel list.

A user may invoke the HISTORY feature by pressing one or more specified keys. In this regard, although FIG. 2 shows a dedicated HISTORY key 264, it will be apparent that the HISTORY feature may be otherwise invoked such as by pressing a combination of keys each of which is normally individually associated with other features. For purposes of this discussion, it will be assumed that remote control 250 includes a dedicated HISTORY key 264 that is pressed by the user to invoke the HISTORY functionality.

The HISTORY feature displays a list of past channels a viewer has watched and is particularly useful when a video recording device is connected to the television such as an HDD recorder, a DVD recorder, or an HDD/DVD recorder. Such a recorder may save watched programs in a temporary cache, which can be played back by making selections from the history list.

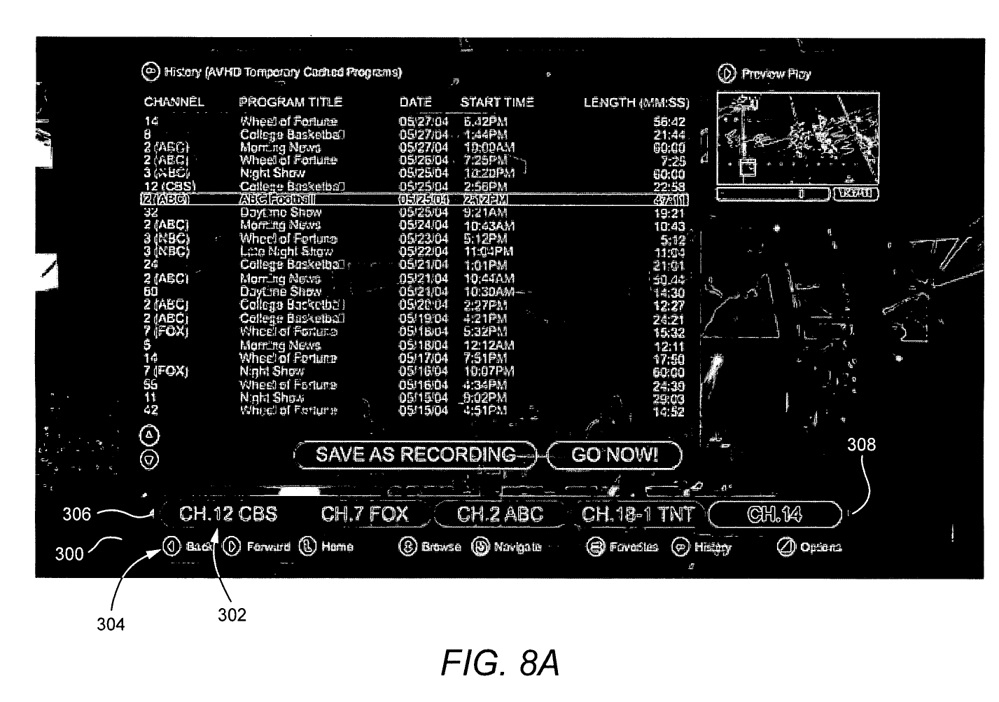

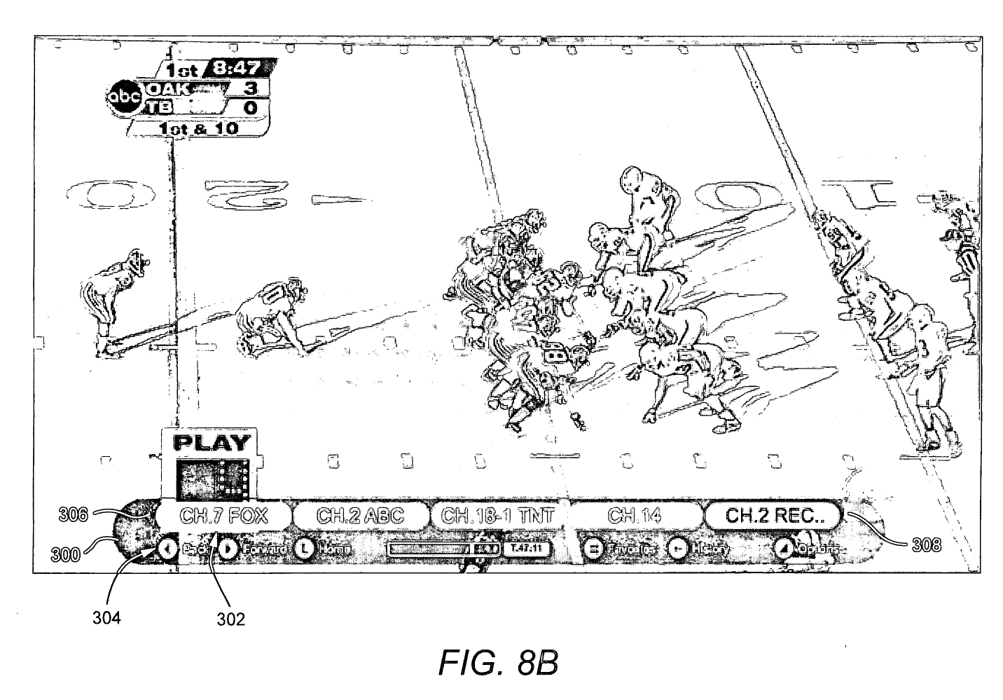

With reference to FIG. 8A, the history list shows past pause/live caches in descending date order. Cached records are useful when viewers want to browse through previously watched programs, save a cached program as a recording, or to view a past program in full screen instantly. Information such as channel, program title, date, start time, and length help the user determine what was cached. A preview window may be provided to allow the viewer to instantly view the highlighted program. In the display of FIG. 8A, ABC Football has been selected and enter key 252 may be pressed to view this program in full screen as shown in FIG. 8B. Once the viewer is watching the cached recording, a playback bar is added to the user prompts 904 in place of the NAVIGATE and BROWSE prompts present in user prompts 304, for example. In addition, the information in the channel list (e.g., “REC”) helps differentiate a recording from live television.

In an example embodiment, the cached recording information is integrated in the channel browse list and thus the channel browse list may include one or more cache recordings. Consequently, the user still has access to all the basic navigation methods using, for example, arrow keys 254a-d of remote control 250 as described above. In this example embodiment, playback of a particular cached recording may be paused when the user navigates to other channels on the channel list and may be resumed when the user navigates back to the particular cached recording on the channel list. This may be accomplished by control section 214 issuing commands that are forwarded to the recording device, for example, via interface 202.

In still other example embodiments, other video inputs supplied to the television may be integrated into the channel browse list. For example, outputs from DVD players, VCRs and the like may be included in the channel browse list. Playback from these devices may be controlled on whether the output from the devices is highlighted in the channel browse list. For example, if the DVD player output is highlighted, the DVD player may be controlled to be in “Playback Mode.” When the highlight is removed from the DVD player, the DVD player may be paused. This may be accomplished for example by control section 214 generating appropriate DVD control signals which may be transmitted via remote control interface 216 to the remote control receiver of the DVD player.

A user may invoke the OPTIONS feature by pressing one or more specified keys. In this regard, although FIG. 2 shows a dedicated OPTIONS key 266, it will be apparent that the OPTIONS feature may be otherwise invoked such as by pressing a combination of keys each of which is normally individually associated with other features. For purposes of this discussion, it will be assumed that remote control 250 includes a dedicated OPTIONS key 266 that is pressed by the user to invoke the OPTIONS functionality.

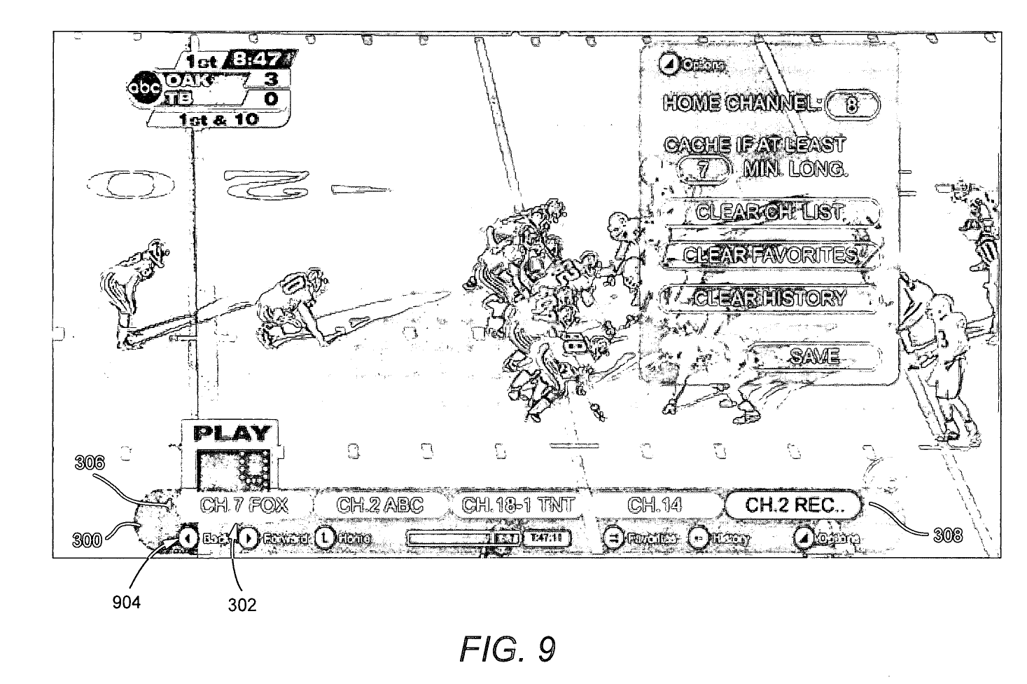

The OPTIONS feature allows the user to customize the interface. When the OPTIONS feature is invoked, the display of FIG. 9 is provided and allows the user to set basic settings for the interface. A home channel may be set by highlighting that setting, and entering a channel number. This home channel may tuned by pressing HOME key 256 (as long as the interface is not in NAVIGATE mode). Which cache recordings to keep in the history list may be set, for example, by setting “Cache if at least XXX minutes long.” The viewer also has the option to instantly clear the channel list, favorites pages or history caches. Other options may be provided to clear or reset the channel ranking list.

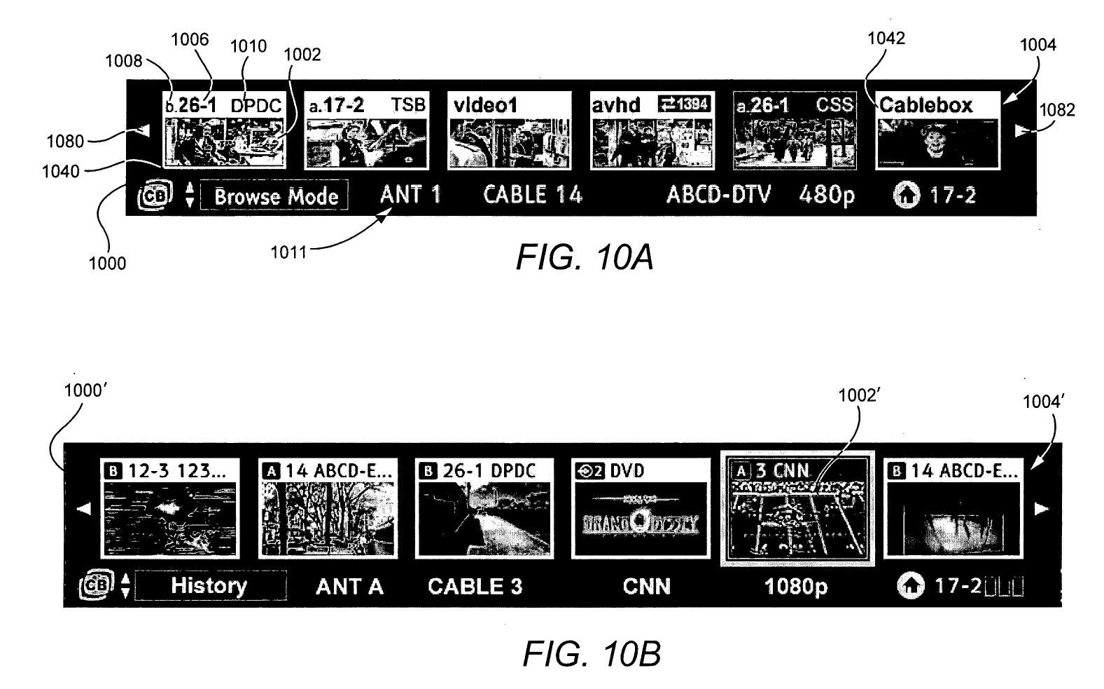

FIG. 10A shows another example browser bar I 000 that may be used in the interface described herein. Browser bar I 000 includes still image (pictorial) information 1002 for each entry in channel/input list 1004. Each list entry also includes a list box 1042 having one or more of channel/input information 1006, antenna input information 1008 and label information 1010 as appropriate. Other information may additionally or alternatively be provided. Arrows 1080 and 1082 to the left and right respectively of the channel list 1004 show that there are channels/inputs in the list that are out of view.

Information about the currently tuned channel is contained in channel bar 1011. In the example channel bar 1011, the input source (e.g., Antenna 1, Antenna 2, STB (set-top box)), the channel number (cable 14), the channel call letters (ABCD-DTV) and the channel resolution (480 p) are provided. Other information may additionally or alternatively be provided.

In the example browser bar 1000, a highlight box 1040 is used to indicate which list entry is currently selected. In the FIG. 10A example, highlight box 1040 indicates that channel 26-1 (DPDC) is currently selected. A darkened list box 1042 indicates the currently tuned channel. In the FIG. 10A example, darkened list box 1042 indicates that channel 26-1 (CSS) is the currently tuned channel.

Still image information 1002 assists the user in determining what he or she may want to watch. The image information may be generated in various ways. In one example implementation, the image information is generated by saving in memory 220 images from the channels and/or inputs which are obtained as the user tunes to or selects channels and inputs in list 1004. These images can be low-resolution images and may additionally or alternatively be limited to only a portion of the complete image from the selected channels and/or inputs.

For purposes of memory conservation and management, an upper limit (e.g., 32) may be placed on how many channels may be included in channel/input list 1004. In addition or alternatively, upper limits may be placed on the number of images that may be contained in a particular list and/or on the total number of images that may be contained in all lists combined.

As shown in FIG. 10A, both television channels and inputs are provided in the same browser bar 100. These inputs may include without limitation video input(s) from a DVD player, VCR, etc.; DVI or HDMI input(s); ColorStream input(s); personal computer input(s); and the like. By way of example, a user can be watching a television channel and switch to a video input, ColorStream input, DVI or HDMI input or PC input. Both the television channel and the input are added to channel/input list 1004 and the user can thereby easily go back and forth between television channels and inputs that have been selected for viewing. As is further shown in FIG. 10A, channel/input list 1004 allows channels from a plurality of different antennas (e.g., antenna 1 and antenna 2) to be mixed together in a single channel/input list. The respective antennas are identified by antenna input information 1008. By way of example without limitation, “a” is used to designate Antenna 1 and “b” is used to designate Antenna 2. The mixing of channels from different antenna inputs in the same channel list allows greater flexibility in creating channel/input list 1004 and allows the user to switch antenna inputs seamlessly.

IEEE 1394 devices may also be included in channel/input list 1004 as such devices are selected by the user. The user can then transition from a 1394 device (e.g., AVHD, DVHS, set-top box, and the like) to a television channel and/or to another video input by moving backward and forward through channel/input list 1004.

Devices that have custom labeling may have these custom labels displayed in channel/input list 1004. These custom labels may include, by way of example, a brand or type associated with a cablebox or Irlink device. The text for such labels may be provided to television 200 by the devices themselves or may be entered by the user via an on-screen keyboard for example.

Channel/input list 1004 is cleared when the user turns television 200 off. In alternative implementations, the user may configure television 200 (e.g., via menu selections) to save channel/input list 1004 in memory 220 when television 200 is turned off and to load the saved list when television 200 is next tuned on. In still another implementation, the user may selectively save in memory 220 a plurality of different channel lists and/or channel/input lists. The selectively saved lists may be respectively associated with particular users (e.g., Dad's list, Mom's list, Sally's list, etc.). The saving operation may be initiated by one or more menu selections provided as part of the interface. The saved lists may be loaded from memory 220, this loading operation being initiated by one or more menu selections provided as part of the interface.

In an alternative implementation, one or more or all of the still images 1002 stored in memory 220 may be periodically and automatically updated. For example, if multiple NTSC and/or ATSC tuners are provided in television 200, one or more of the tuners can be controlled by control section 214 to scan the channels or inputs in the list while the user is watching some currently tuned channel (or other video input) to thereby obtain new still images for these channels or inputs. In this way, the still images can better reflect the current content of the channels or inputs in the list.

In still another alternative implementation shown in FIG. 10B, browser bar 1000′ includes video (moving) image information 1002′ for one or more of the channels/inputs in channel/input list 1004′. In the example browser bar 1000′, the same moving video is output on the main video display and for list entry 1020. The moving video is frozen by capturing a still image when the user moves to another entry on the list.

In yet another alternative implementation, one or more or all of the still images for channels or inputs in the list may be an image for, for example, a future program on a particular channel. By way of illustration without limitation, the image may promote an upcoming show or an upcoming episode of a show or a special event (e.g., sporting event, movie, awards show, etc.). These images may be communicated to the television as part of the transport stream received by television 200. Control section 214 detects these communicated images and updates the lists in memory 220 as appropriate.

Various modifications may be made to the browsing described in connection with FIGS. 3A-3O and FIGS. 10A and 10B. For example, a channel retrace capability may be provided so that television 200 can intelligently determine when the same history path is detected and then move forward or backward in the list based on this determination. By way of further example, channels or inputs already in the channel or channel/input list may be moved to the front of the list when tuned to or selected (visited) again, rather than being added as a duplicate list entry. In this way, only unique channels appear on the list and the channels that a user watches are moved more closely to the end of the list.

FIG. 11 shows an illustrative screen display for explaining an example method of customizing a channel or channel/input list. In this example method, television 200 scans through the accessible channels, which are displayed in window 1102 as they are scanned. The user may adjust the scan speed to determine how fast or slow the accessible channels are scanned. In this example, the scan speed can be set in a range from a minimum scan speed (e.g., two seconds per channel) to a maximum scan speed (e.g., ten seconds per channel) using left and right arrow keys 254b, 254d on remote control 250. When the user wishes to add a currently displayed channel or input to a selected position in the list, he or she presses enter button 252 on remote control 250. Up and down arrows keys 254a and 254c of remote control 250 are used to select apposition in which the channel or input is added to list 1130. The current position in list 1130 is indicated by arrow 1132. An option is provided to clear the list (e.g., by pressing a specified button such as an “Info” key 293 on remote control 280). This customized channel or channel/input list may be saved in memory 220 and loaded for subsequent use. While the FIG. 11 screen display is based on the automatic scanning of the accessible channels, in another implementation the user can use a channel up/down key (e.g., key 290 of remote control 280) to manually tune the channels. Moreover, the scanning may include scanning of the various video inputs and devices connected to television 200.

FIG. 12 shows a portion of another example browser bar 1200 that may be used in the interface described herein. Browser bar 1200 includes a list 1202 with entries for applications that can be executed by control section 214 of television 200. In particular, list 1202 includes entries 1204, 1206 and 1208 for a picture viewer application, an MP3 player and a video player, respectively. Other applications such as network applications, video applications, streaming applications, internet applications, and the like may also be included in list 1202. Although not shown in FIG. 12, list 1202 may include entries for television channels, IEEE 1394 devices and other video inputs so that the user may easily select from among these various entries.

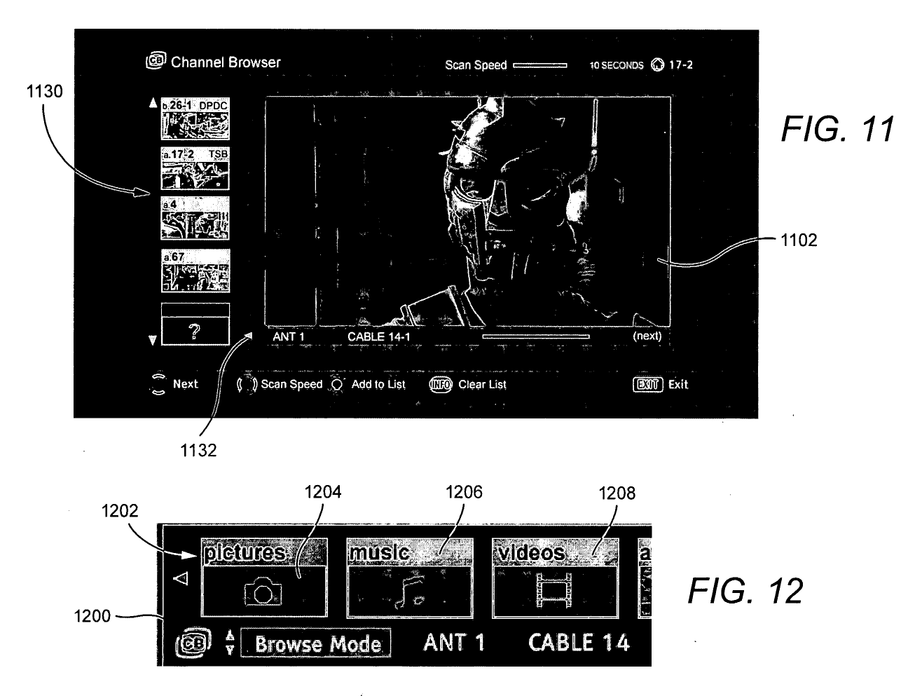

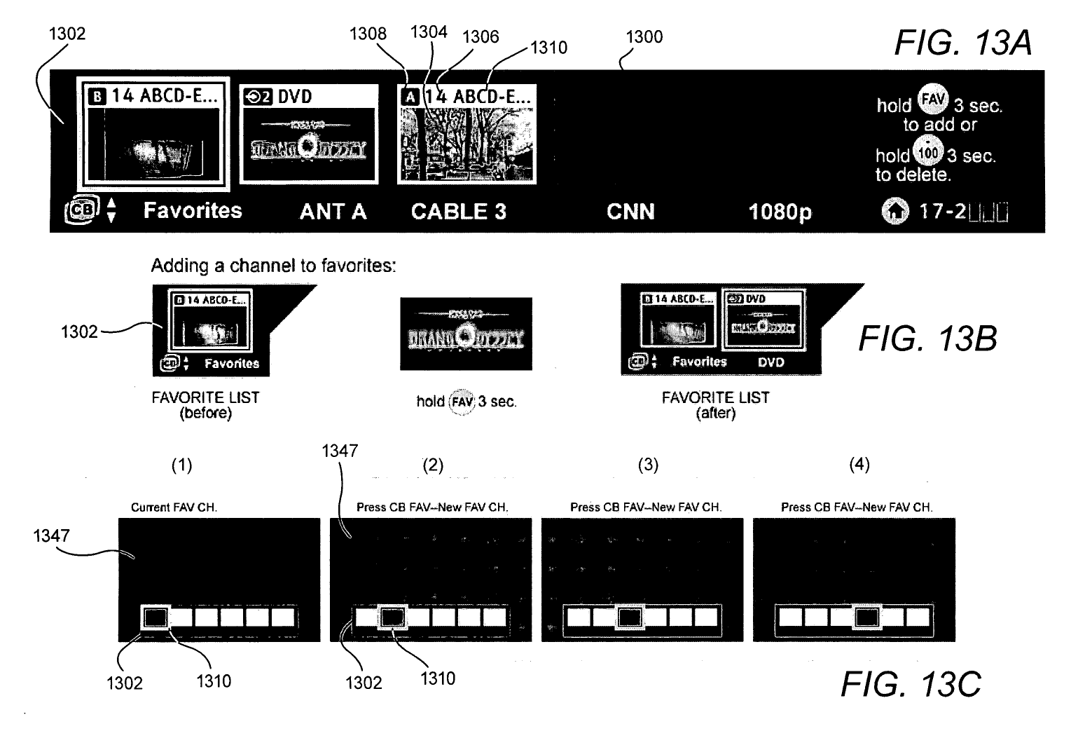

FIG. 13A shows an example favorite channel bar 1300 that may be used in the interface described herein. Favorite channel bar 1300 displays a list 1302 of channels or inputs. Each entry in the list includes a still image 1304. One or more of channel/input information 1306, antenna input information 1308 and label information 13 10 may also be included as appropriate. A currently viewed channel can be added to list 1302 by, for example, pressing a specified key on remote control 250 (e.g., “Fav” key 292 of remote control 280) for a specified period of time (e.g., three seconds). A channel currently on list 1302 can be deleted from the list by highlighting the channel and pressing a specified key on remote control 250 (e.g., “−/100” key of remote control 280) for a specified period of time (e.g., three seconds).

FIG. 13B shows an example sequence of display portions for explaining how a channel is added to list 1302. List 1302 initially includes an entry for channel 14 (ABCD-E) on Antenna 1. While the DVD input is selected and the output thereof is displayed in the main display window, the user presses “Fav” key 292 of remote control 280 for three seconds. List 1302 is then updated to include an entry for the DVD input.

FIG. 13C shows an example sequence of displays for explaining how to cycle through the favorite channels in list 1302. With reference to (1), the current favorite channel is displayed in the main display window 1347 and the corresponding entry in list 1302 is provided with a highlight 1310. By pressing “Fav” key 292 on remote control 280, the next favorite channel in list 1302 is displayed in main display window 1347 and the corresponding entry in list 1302 is provided with highlight 1310 as shown in (2). Repeated pressing of “Fav” key 292 sequentially selects the next favorite channel in list 1302 and causes this favorite channel to be displayed in the main display window and a highlight to be provided for the corresponding entry in list 1302 as shown in (3) and (4). After the last favorite channel in list 1302 is selected, pressing “Fav” key 292 again will result in cycling back to the first favorite channel in list 1302.

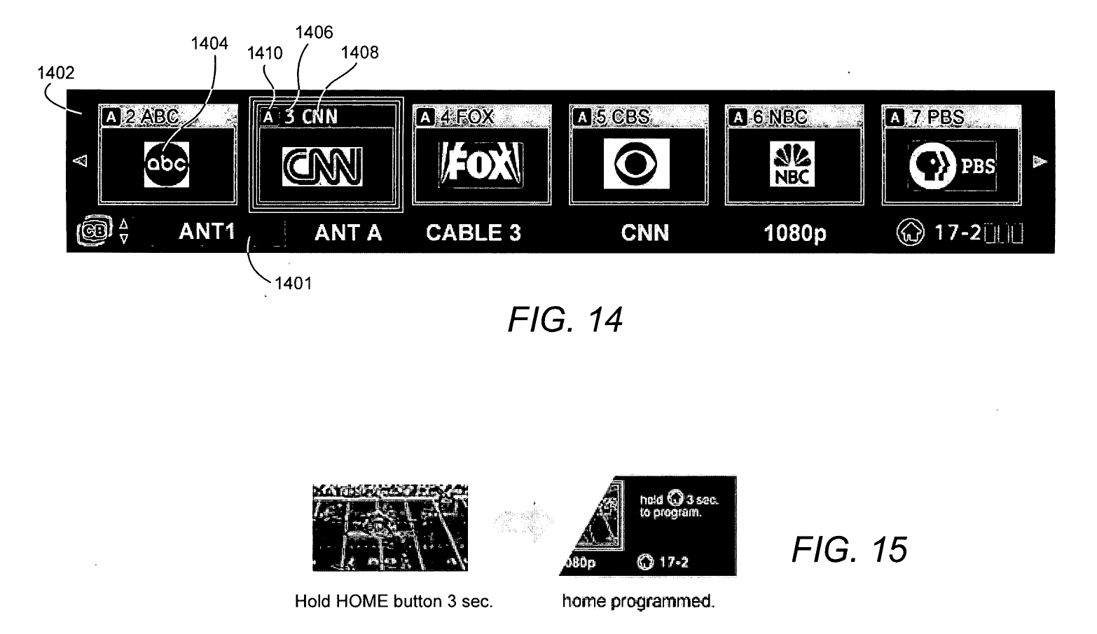

FIG. 14 shows an example display portion for explaining a channel list feature. A channel list is a list of channels associated with a particular input to television 200. For example, there may be respective channel lists associated with the Antenna 1 input, the Antenna 2 input, the set-top box input, etc. The channel list for a particular input may be viewed by selecting a label for that input from list box 1401. After selecting the label, channel list 1402 for the input corresponding to the selected label is displayed. Each entry in list 1402 includes a channel logo 1404 for the corresponding channel, along with a channel number 1406, call letters 1408, and input information 1410. Of course, this arrangement of information for the channels in channel list 1402 is provided by way of example without limitation and it will be apparent that other arrangements are possible. As discussed above with reference to FIGS. 10A and 10B, an image for, for example, a future program may additionally or alternatively be provided for one or more of the channel entries in channel list 1402. The logos and/or images may be communicated to the television as part of the transport stream received by the television and may be stored in memory 220, for example, as part of a program guide database.

FIG. 15 shows example display portions for explaining a manner of setting a HOME channel. In the case of remote control 280 shown in FIG. 2B, for example, a dedicated “home” button 285 is included. Of course, it will be apparent that the HOME channel may be set by pressing a combination of keys each of which is normally individually associated with other features if no dedicated “home” button is provided. When a remote control having a dedicated home button is used, the channel currently displayed in the main display window can be set to be the HOME channel by pressing home button 285 for a specified period of time (e.g., three seconds). The HOME channel can then be accessed by pressing home button 285 (for less than the specified period of time).

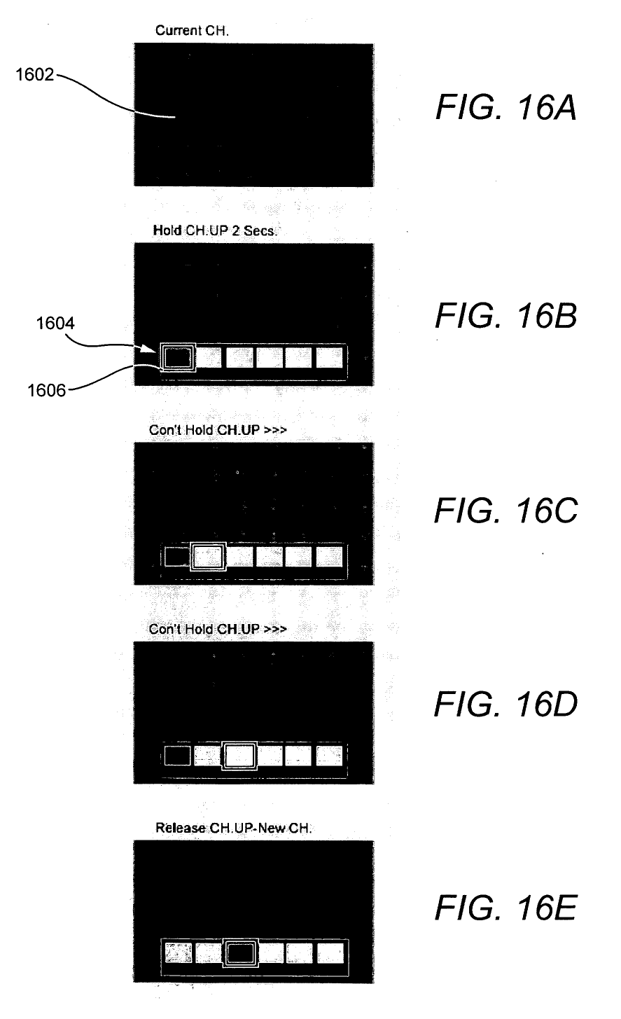

FIGS. 16A-16E show example displays for explaining a channel surfing operation using the interface described herein. FIG. 16A shows a display 1602 of a currently tuned channel. The user then presses a channel up button 290 of remote control 280 for a specified period of time (e.g., two seconds), which causes a channel list 1604 to appear with the list entry for the currently-tuned channel being highlighted by highlight box 1606 as shown in FIG. 16B. Continuing to press the channel up button causes the entry for the next channel in the channel list to be highlighted while the originally-tuned channel continues to be tuned to as shown in FIGS. 16C and 16D. When the user releases the channel up button, the channel corresponding to the then-highlighted channel entry in the channel list is tuned to as shown in FIG. 16E.

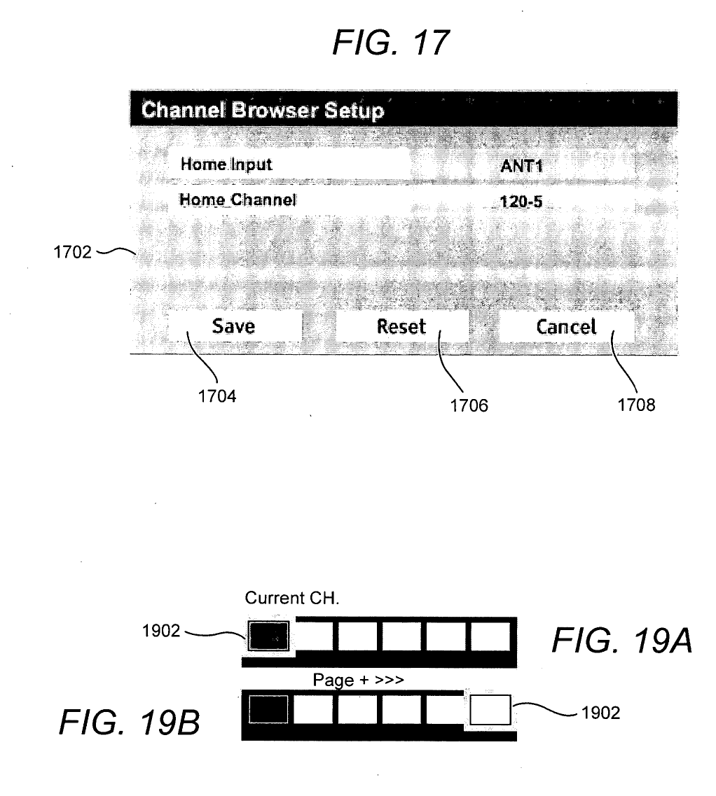

FIG. 17 is another example display screen used to explain configuring the interface described herein. Display screen 1702 is an example channel browser setup screen for the home channel and shows the current setting for the home channel input (i.e., Antenna 1) and the home channel number (i.e., 120-5). The user may change these settings via this setup screen using remote control 250/280 and save the settings using button 1704. A reset button 1706 resets the home channel to a default setting and a cancel button 1708 cancels any current changes made to the home channel settings. It will be readily apparent that setup screens for setting other parameters of the interface described herein may be provided.

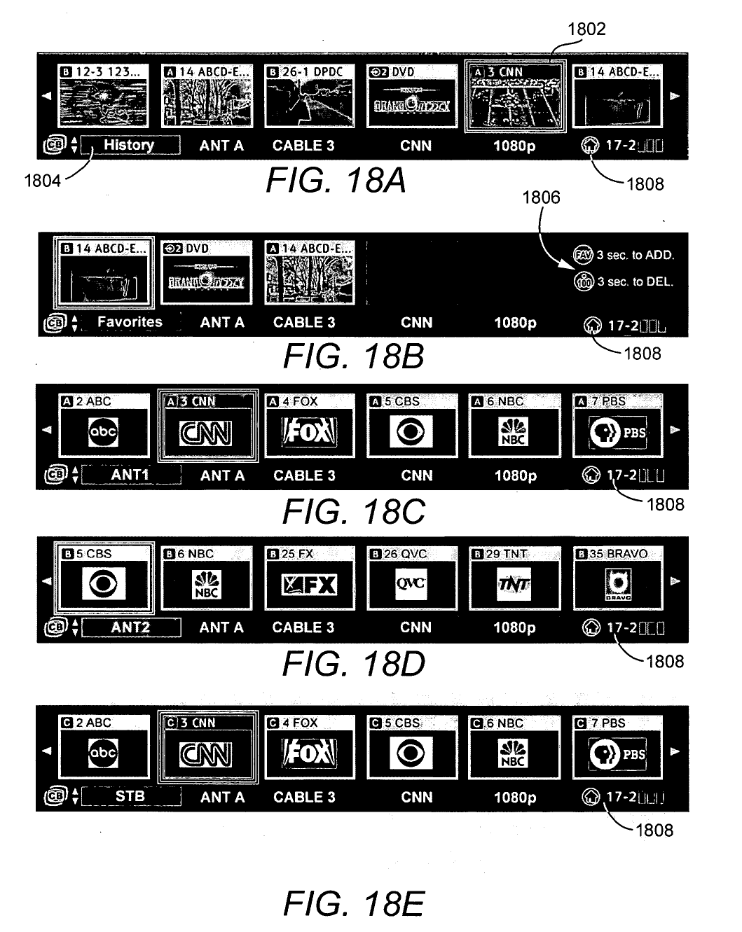

FIGS. 18A-18E are example display screens used to explain switching lists. FIG. 18A shows a “history” list associated with the channel browser as discussed above with respect to FIGS. 10A and 10B. The main display window displays the channel corresponding to the history list entry highlighted by highlight box 1802. Using the list box 1804, the user may switch among different lists. For example, list box 1804 can be used to select the Favorite Channels list as shown in FIG. 18B. As shown in FIG. 18B, the Favorite Channel list provides instructions 1806 for the user to modify the Favorite Channel list in the Favorite Channel browser. FIGS. 18C-18E show channel list browsers for the Antenna 1, the Antenna 2 and the STB (set-top box/cable) inputs to television 200, respectively. The lists in FIGS. 18A-18E include unified home channel indicia 1808 indicating the home channel (i.e., channel 17-2) that has been set by the user.

FIGS. 19A and 19B are example display screen portions used to explain the operation of Page ± buttons 287, 288 of remote control 280 when lists such as those in FIGS. 18A-18E are displayed. In particular, FIG. 19A shows highlight box 1902 positioned at the left-most list entry. Pressing “Page +” button 287 of remote control 280 moves highlight box 1902 to the right-most list entry as shown in FIG. 19B. Pressing the “Page” button 288 from the display of FIG. 19B would cause the highlight box to again highlight the left-most list entry.

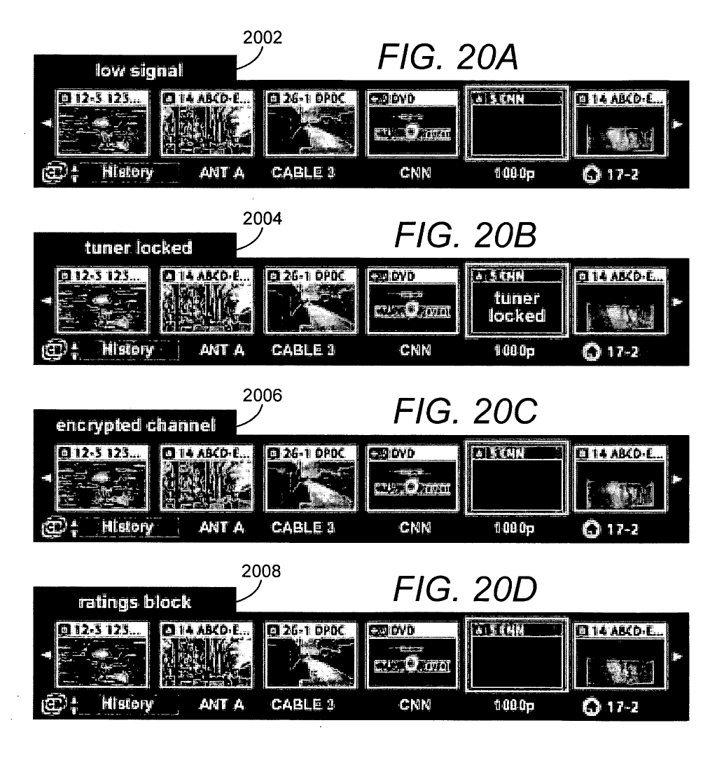

Channel browser lists may include channel status information for one or more channels in a currently displayed list. By way of example without limitation, FIGS. 20A-20D are example channel browser lists that include channel status information providing reasons why a user may not see video for a particular channel highlighted in the list. In the FIG. 20A example, channel status information 2002 indicates that highlighted channel 3 (CNN) has a weak signal and cannot be seen. In the FIG. 20B example, channel status information 2004 indicates that highlighted channel 3 (CNN) cannot be seen because the tuner is locked. In the FIG. 20C example, channel status information 2006 indicates that highlighted channel 3 (CNN) cannot be seen because the channel is encrypted. In the FIG. 20D example, channel status information 1008 indicates that highlighted channel 3 (CNN) cannot be seen because the content thereof exceeds an acceptable rating level set using a parental control function.

The various aspects of the interface described herein may be implemented as part of an operating program executed by control section 214. This program can, for example, be tangibly embodied on a computer-readable medium such as memory 220. Memory 220 may include magnetic memory, optical memory, semiconductor memory, magneto-optic memory, combinations thereof and the like. In another example, the program may be available for downloading over the internet so that the program may be delivered to television 200 via a communication network. Updates to the interface may be provided via downloads to television 200. Further, a carrier wave may be modulated by a signal representing the corresponding program and an obtained modulated wave may be transmitted, so that the television that receives the modulated wave may demodulate the modulated wave to restore the corresponding program.

While the discussion above has been with reference to example embodiments, variations of the example embodiments will be readily apparent and this application is intended to cover various modifications and equivalent arrangement included within the spirit and scope of the appended claims.

I claim:

1. A method for selecting television channels, comprising:
generating a channel list based on tuning operations of a tuner of a television;
providing an interface that displays at least a portion of the channel list and allows for user-selection of a channel from the channel list; and
tuning to the selected channel.

2. The method according to claim 1, wherein the generating of the channel list is further based on playback of one or more recordings by an external device connected to the television and the interface displays at least one of the recordings of the channel list and allows for user-selection of the recordings from the channel list.

3. The method according to claim 2, further comprising:
pausing the playback of the recordings when the recordings are not selected by the user.

4. The method according to claim 1, wherein the interface provides the channel list in an overlay onto the display of a currently-tuned channel.

5. The method according to claim 1, wherein the generating of the channel list comprises adding a channel to the end of the channel list when the user tunes to that channel.

6. The method according to claim 1, wherein the channel list contains two or more entries for the same channel.

7. The method according to claim 1, further comprising:
saving the channel list generating during a viewing session to provide an initial channel list for a subsequent viewing session.

8. The method according to claim 1, further comprising:
clearing the channel list when the viewing session during which it is generated ends.

9. A television comprising a control section programmed to perform the method of claim 1.

10. A storage medium storing program instructions executable by a processor to perform the method of claim 1.

11. A channel selection system, comprising:
a storage device; and
a control system,
wherein the control system generates a channel list that is stored in the storage device based on tuning operations of a tuner of a television, generates display signals for displaying at least a portion of the channel list, and generates tuning control signals for tuning a tuner to a channel selected from the channel list by a user.

12. The system according to claim 11, wherein the control system further generates the channel list based on playback of one or more recordings by an external device connected to the television, generates display signals for displaying at least one of the recordings of the channel list, and generates control signals allowing output of the recordings from the channel list.

13. The system according to claim 12, wherein the control system generates control signals for pausing the playback of the recordings when the recordings are not selected by the user.

14. The system according to claim 11, wherein the channel list is provided as an overlay on the display of a currently-tuned channel.

15. The system according to claim 11, wherein the control system generates the channel list by adding a channel to the end of the channel list when the user tunes to that channel.

16. The system according to claim 11, wherein the channel list contains two or more entries for the same channel.

17. The system according to claim 11, wherein the maximum length of the channel list is user-configurable.

18. A television including the channel selection system of claim 11.

19. A method for selecting displays for televisions, comprising:
generating a list based on tuning operations of a tuner of a television and on selections of inputs from external devices to the television;
providing an interface that displays at least a portion of the list and allows for user-selection of a channel or an input from the list; and
displaying video from the selected channel or input.

20. The method according to claim 19, wherein the list includes static images associated with the tuning operations and input selections.

21. The method according to claim 19, wherein the list includes video images associated with the tuning operations and input selections.
